(19) United States
(12) Patent Application Publication
(10) Pub. No.: US 2022/0175176 A1
(43) Pub. Date: Jun. 9, 2022

(54) DEVICES AND METHODS FOR BREWING BEVERAGES

(71) Applicant: Innovative Brewing, LLC, Branford, CT (US)

(72) Inventors: David Y. LIGHT, Branford, CT (US); Oded LIGHT, Branford, CT (US)

(21) Appl. No.: 17/436,345

(22) PCT Filed: Mar. 6, 2020
(86) PCT No.: PCT/US2020/021453

§ 371 Date: Sep. 3, 2021

Related U.S. Application Data
(60) Provisional application No. 62/814,849, filed on Mar. 6, 2019.

(51) Int. Cl. A47J 31/18; A47J 31/42; A47J 31/06; A47J 31/44; A23F 5/08; A23F 5/26

(52) U.S. Cl. CPC A47J 31/18; A47J 31/42; A23F 5/26; A47J 31/4471; A23F 5/08; A47J 31/0689

(57) ABSTRACT

The present disclosure generally relates to devices and methods for brewing beverages. More specifically, aspects of the present disclosure include devices suitable for brewing coffee from coffee beans which have been ground by the device using a rotor-stator assembly, and methods of brewing coffee using such a device.

### CROSS-REFERENCE TO RELATED APPLICATION

This application claims the benefit of U.S. Provisional Application Ser. No. 62/814,849, entitled “DEVICES AND METHODS FOR BREWING BEVERAGES” and filed on Mar. 6, 2019, which is expressly incorporated by reference herein in its entirety.

### BACKGROUND

There are many devices for brewing coffee. In a typical consumer-grade coffee making device, the user loads coffee grounds into a container in the device, and hot water is contacted with the coffee grounds such that water soluble components from the coffee grounds are extracted by the water. The coffee grounds are filtered from the mixture, resulting in hot coffee.

Traditional drip-based coffee makers typically comprise a filter basket that receives a coffee filter, ground coffee and water. The filter basket normally includes an outlet opening disposed in the center of the basket. Hot water is introduced into the top of the filter basket and contacts the coffee grounds such that water soluble components from the coffee grounds are extracted by the water, and exits through the outlet opening as a beverage (i.e., coffee), while the remaining coffee grounds are filtered from the mixture by the filter basket.

Conventional drip-based methods can produce a hot beverage within minutes. However, this technique typically fails to extract poorly soluble fats, fatty acids and other lipid-based compounds present in coffee beans. Solubility/extraction of poorly soluble compounds is often enhanced at higher temperatures, but the limited steeping time and structure of drip-based brewing devices is normally unfavorable for extraction of these compounds, resulting in limited or undetectable amounts of these compounds in coffee produced using conventional drip-based methods.

French press coffee brewing devices typically include a cylindrical glass container with a plunger that slides vertically along the central axis of the container. The head of the plunger includes a mesh filter. To make a pot of coffee, the plunger is removed from the container and coarse grounds are placed in the bottom of the container. Hot water is then added and stirred with the grounds. The coffee grounds are then allowed to steep for an appropriate length of time in order to allow extractable components to be extracted by the hot water. Finally, the plunger is depressed, collecting the free-floating grounds at the bottom of the container. Water and water extractable components from the coffee grounds pass through the filter. The resulting coffee beverage is normally served directly from the container. Coffee produced using the French press method is considered by some to be superior to drip-based brewing. However, conventional French press methods are only capable of extracting a very small amount of oil from coffee beans, limiting the range of taste and aroma profiles of beverages brewed using this method.

The structure of the conventional French press device is not ideal in that coffee grinds are collected by the plunger at the bottom of the steeping vessel. As a result, the steeping process cannot be terminated unless all of the coffee beverage in the vessel is poured out (i.e., to allow the user to remove the grinds collected at the bottom of the vessel). As a result, users cannot brew a batch of French press coffee, dispense a portion or single serving of the brewed beverage and then store the remaining coffee in the vessel because steeping will continue in the interim. Over-steeped coffee grinds typically produce a poor-quality coffee beverage. French press coffee may also have an undesirable chalky taste profile in some instances due to poor filtering and/or use of the device with coffee that has been ground too finely.

Coffee may also be produced using a cold brew process, which typically involves steeping coffee grinds in water for a prolonged period of time (e.g., ˜14-18 hours) at room temperature or a chilled temperature, and then separating the grinds from the resulting coffee beverage using a filter. The extended steeping time used by cold brew protocols allows one to brew a cup of coffee without the use of hot water which would otherwise change the flavor profile, resulting in a beverage with a unique extraction profile compared to standard drip-based brewing methods. Cold brew coffee has become increasingly popular in recent years, at least partially due to the perception by many users that cold brew coffee has improved flavor and aroma profiles compared to conventional coffee. However, adoption and commercialization of cold brew methods has been limited due to the long steeping time required by this method (e.g., users must plan ahead by ˜14 hours). As a result, cold brew methods have failed to supplant conventional drip-based brewing.

In sum, while methods of brewing coffee using drip-based, French press, and cold brew devices may be adequate for brewing a traditional cup of coffee, they suffer various limitations. For example, standard drip-based brewing techniques are fast but are often unable to extract a substantial portion of the desirable organic compounds present in coffee beans, e.g., drip-based methods typically fail to extract any measurable amount of oil from the coffee and the high heat required by this method may worsen the taste of the resulting beverage. French press methods are capable of extracting a small portion of the oil contained in the coffee beans but also require high heat which may negatively impact the flavor of the coffee, and also require substantial manual preparation by the user (a user must grind beans, heat water, mix the grinds and water, and filter the resulting coffee beverage). Cold brew methods typically fail to extract a substantial amount of the oil and other poorly soluble (or extractable) compounds in coffee and also require a sizable investment of time, e.g., 12-16 hours. None of these existing devices or methods provides fast brewing, high oil extraction and the option to completely avoid heat damage.

### SUMMARY

The present disclosure provides devices and methods for brewing beverages that may avoid one or more of the limitations of traditional methods of brewing beverages, such as high-temperature drip-based, French Press and/or cold brewing methods. For example, the devices and methods described herein can provide one or more of the following advantages compared to such traditional systems and methods:
an all-in-one system for grinding and brewing beverages that does not, for example, require a user to separately grind coffee beans or heat water after grinding;
an expanded palette of flavor profiles, an improved composition, color, and/or properties, and/or an enhanced extraction of beneficial organic compounds, resulting in unique, enhanced and/or alternative flavor and/or aroma profiles;
an increased concentration and/or amount of beneficial compounds;
enhanced extraction of fats, fatty acids and other poorly soluble compounds;
an improved filtration process that results in reduced particulate levels;
a removable rotor-stator assembly adapted to fit within a beverage brewing device;
ease-of-use (e.g., easy to measure amount of coffee; easy to clean; customizable features such as coffee flavors, brew intensities, and temperatures; and faster brewing);
an enhanced user experience that permits, for example, the user to visualize active grinding and brewing; and
a full brewing process with substantially no exposure to oxygen and thus prevents oxidative damage (which degrades the flavor of coffee produced using traditional methods).

These and other features that improve upon currently available systems for brewing beverages are described in detail herein.

Disclosed herein are various devices and methods that may be used to brew a beverage, and, in particular, devices and methods for brewing coffee using a wet grinding process that uses a rotor-stator assembly. The coffee brewing devices and methods disclosed herein, in some aspects, produce coffee that may be enriched with a higher concentration of beneficial compounds such as antioxidants and polyunsaturated fatty acids compared to traditional drip-based and French press coffee brewing devices. The rotor-stator assembly incorporated into brewing devices according to some aspects of the disclosure may also be used to produce a consistent particle size, resulting in beverages which have a superior taste and/or texture profile compared to beverages producing using traditional methods. In addition to providing unique extraction and grinding profiles, aspects of the disclosure also may provide efficient coffee brewing devices for consumer and commercial use.

In some aspects, the disclosure provides various configurations of a rotor-stator assembly adapted for use with a beverage brewing device, comprising a stator capable of holding one or more edible materials (e.g., coffee beans), wherein the stator includes one or more openings (e.g., a plurality of holes present in the casing of the stator); and a rotor positioned within the stator, wherein the rotor has at least one flute (e.g., adapted to cooperate with the stator to perform grinding). In some aspects, the rotor may comprise a plurality of flutes having any shape, arrangement, or orientation described herein. The rotor-stator assemblies disclosed herein may be adapted to grind the edible materials (e.g., coffee beans) when fully or partially submerged in a liquid (e.g., water).

In some aspects, the rotor-stator may comprise a rotor, rotatable about a central axis, and comprising at least one flute extending outward from the central axis; and a stator comprising a cylindrical casing surrounding the rotor, said casing including one or more holes, wherein the rotor-stator is capable of grinding (or adapted to grind) solid edible materials while submerged in a liquid. The rotor component of the rotor-stator may comprise any number of flutes extending outward from the central axis, said flutes being adapted to cooperate with the stator to perform grinding. In some exemplary aspects, the rotor may comprise two or more flutes extending outward from the central axis (e.g., wherein each flute is positioned at a different plane along the central axis and there is only one flute per plane). In some aspects, the rotor further comprises a baffle positioned above or below the stator, the baffle being a structure adapted to reduce, disrupt or prevent the formation of a vortex during the grinding process. The baffle may be integrally attached to the stator. In other aspects, the baffle may be detachable (e.g., the baffle and a surface of the stator may have corresponding threading allowing these elements to be connected). The rotor-stator assembly (and optionally, the baffle) may be attached or attachable to a support framework (e.g., a scaffold) adapted to fit inside the container. In some aspects, the rotor comprises a single flute extending outward from the central axis. In some aspects, the rotor comprises one or more flutes that are each counter-balanced by a portion of the rotor that is not a flute.

In some aspects, the one or more openings in the stator may comprise any arbitrary diameter. For example, the diameter of the openings may be approximately (or exactly) 0.25 mm, 0.50 mm. 0.75 mm, 1.00 mm, 1.25 mm, 1.50 mm, 1.75 mm, 2.00 mm, 2.25 mm, 2.50 mm, 2.75 mm, 3.00 mm, 3.25 mm, 3.50 mm, 3.75 mm, 4.00 mm, 4.25 mm, 4.50 mm, 4.75 mm, 5.00 mm, 5.25 mm, 5.50 mm, 5.75 mm, 6.00 mm, 6.25 mm, 6.50 mm, 6.75 mm, 7.00, 7.25 mm, 7.50 mm, 7.75 mm, 8.00 mm, 8.25 mm, 8.50 mm, 8.75 mm, 9.00 mm, 9.25 mm, 9.50 mm, 9.75 mm, or 10.00 mm. In some aspects, the one or more openings in the stator may have a diameter in a range bounded by endpoints selected from any pair of the preceding sizes (e.g., between 4.75 and 5.25 mm).

The rotor-stator assembly may be configured to generate an arbitrary particle size suitable for a given beverage when incorporated into a beverage brewing device. In some aspects, the rotor-stator assembly may be configured to generate an average, minimum, or maximum particle size of 10-1,000 μm, or any subrange thereof (e.g., 10-50 μm, 10-100 μm, 10-250 μm, 10-500 μm, 20-60 μm, 30-70 μm, 40-80 μm, 50-90 μm, 60-100 μm, 100-200 μm, 200-300 μm, 300-400 μm, 400-500 μm, 500-600 μm, 600-700 μm, 700-800 μm, 800-900 μm, 900-1,000 μm). In some aspects, the rotor-stator assembly may be configured to generate an average, minimum, or maximum particle size in a range bounded by a combination of any two endpoints selected from the preceding ranges.

The disclosure also provides various beverage brewing devices 100 compatible with the rotor-stator assemblies 103 described herein. In some aspects, a beverage brewing device 100 may comprise a housing 101, a container 102, and a rotor-stator assembly 103. The container 102 may be adapted to hold a liquid and may also be adapted to receive, contact, or connect to the housing 101. The container 102 may be adapted to receive a rotor-stator assembly 103 (alone or optionally attached to a framework 104). Suitable rotor-stator assemblies 103 include any of the various rotor-stator assembly 103 configurations described herein. In some aspects, the container 102 comprises an internal compartment 107 defined by one or more surfaces (e.g., side walls), wherein fluid communication between the internal compartment 107 and the rest of the container 102 is restricted or controlled. In some aspects, fluid communication is allowed to proceed only through one or more filters 109 positioned on a surface of the internal compartment 107. The internal compartment 107 may be adapted to receive and/or contain the rotor-stator assembly 103. The internal compartment 107 may retain ground-up edible materials produced by the rotor-stator assembly 103 while allowing liquid to flow into the remainder of the container 102 through the one or more filters 109. For example, the rotor-stator assembly 103 and one or more edible materials may be placed in the internal compartment 107 of the container 102. A liquid may be added to the container 102 in a volume sufficient to submerge the rotor-stator assembly 103. Grinding may then proceed, generating a beverage in the internal compartment 107 as extractable (or dissolvable) components in the grinds are steeped in the liquid that circulates during the grinding process. The resulting beverage may diffuse into the remainder of the liquid in the container 102 through one or more filters 109 located on a surface of the internal compartment 107. In some exemplary aspects, the housing 101 comprises one or more elements necessary to operate the rotor-stator assembly (e.g., a power supply 111 or a motor 105). The housing 101 may further comprise an interface 112 configured to allow a user to control or operate the beverage brewing device 100, and/or at least one heating element 110 configured to heat liquid in the container 101 before, during, or after the brewing process.

In some aspects, the housing 101 and/or the container 102 may further comprise a heating element 110, a power supply 111 for the beverage brewing device 100, a motor to drive the rotor-stator assembly 103, and/or an interface 112 that allows a user to control the beverage brewing device 100. For example, the housing 101 and/or the container 102 may comprise a heating element 110 that warms the liquid and/or the brewed beverage. In other aspects, any of these components may be incorporated into an external structure or device (e.g., a base, a remote control, or a mobile device capable of communicating with the beverage brewing device 100).

The novel rotor-stator assemblies disclosed herein may be substituted as the grinder component in any of the pods, beverage brewing devices, and methods described in PCT/US18/49254, filed on Aug. 31, 2018, the contents of which is incorporated by reference in its entirety. Some implementations of a pod may include, for example: an upper wall; a lower wall; one or more side walls connecting the upper wall and the lower wall to form a compartment; a rotor-stator assembly attached to an inner surface of the compartment and adapted to grind an edible material placed in the rotor-stator assembly; wherein at least a portion of the upper wall, the lower wall, or the one or more side walls optionally comprises a filter adapted to allow fluid communication through the pod. An outer surface of the pod may be adapted to attach to a surface of a container and the container may comprise one or more of the following, for example, but not limited hereto: a fluid reservoir; a motor configured to drive the rotor-stator assembly; a switch configured to activate the rotor-stator assembly; and/or a power supply configured to power the rotor-stator assembly. In other aspects, any of these components may be incorporated into a base adapted to interface with the container. Pods according to the disclosure may further comprise, for example: a cap adapted to attach to the pod, the cap being adapted to define an upper wall of the pod.

In some aspects, the rotor-stator assembly in the pod may comprise one or more of the following, for example, but not limited hereto: a rotor having one or more flutes adapted to provide simultaneous grinding and mixing; a rotor having at least one flat flute and at least one bent or curved flute; and/or a rotor having at least one flute with a portion that extends vertically. In some aspects, the rotor-stator assembly may comprise one or flutes adapted to perform grinding by cooperating with the stator. In some aspects, the flute(s) may incorporate angular or curved portions that extend across at least a portion of the length of the stator along the axis of rotation of the rotor. These “fins” may form a surface configured to manipulate the flow of liquid entering and exiting the stator. In some aspects, the fin of the flute may extend along the entire length of the stator along the axis of rotation of the rotor, or along a substantial portion thereof. In some aspects, the rotor may comprise a “U”-shaped pair of flutes adapted to provide force to direct liquid laterally. In still further aspects, the rotor-stator assembly is configured to perform filtration by repeatedly circulating liquid through at least one filter.

In some aspects, a beverage brewing device may comprise any pod described herein; a container, having a top end and a bottom end; wherein the pod comprises a rotor-stator assembly and is configured to attach to an inner surface of the bottom end of the container; and a base adapted to attach to the bottom end of the first container, comprising a motor configured to operate the rotor-stator assembly.

In some aspects, a beverage brewing device comprises, for example: any pod described herein, wherein the pod comprises a rotor-stator assembly; a first base, adapted to allow the pod to attach to an upper surface of the first base; a second base, adapted to allow the first base to attach to an upper surface of the second base, wherein the second base comprises a power supply configured to power the rotor-stator assembly and a motor configured to operate the rotor-stator assembly; a container, having a top end and a bottom end, wherein at least a portion of the bottom end comprises a filter adapted to allow fluid communication between the container and the pod; wherein the pod is configured to attach to an inner surface of the bottom end of the container.

In some aspects, a beverage brewing device comprises, for example: any pod described herein wherein the pod comprises a rotor-stator assembly; a container, having a top end and a bottom end; wherein the container is configured to allow attachment of the pod to an inner surface of the bottom end of the container; and a base adapted to attach to the bottom end of the container, comprising a motor configured to operate the rotor-stator assembly; and optionally, further comprises a support framework extending along a vertical axis of the container, adapted to attach to the pod. Devices according to some embodiments may include a base and/or the container which comprises at least one of the following: a heating element adapted to heat or maintain the temperature of a liquid stored in the container; a switch configured to activate the rotor-stator assembly; and/or a power supply configured to power the rotor-stator assembly.

Some beverage brewing devices according to the disclosure may include a container comprising a fluid reservoir, where the beverage brewing device is configured to enable or block fluid communication between the container and the fluid reservoir of the second container in response to user input. In other aspects, the beverage brewing device further comprises a support framework element positioned within this container (e.g., to isolate coffee beans and partially ground coffee beans above a given size threshold). In some aspects, the support framework comprises a heating element adapted to heat or maintain the temperature of a liquid stored in the container. The support framework used in any of the devices disclosed herein may be further adapted to attach to a lid of the device, which may in turn be detachable.

In some aspects, the filter(s) incorporated into a beverage brewing device (or a pod used with such a device) in accordance with the disclosure may comprise, for example: a mesh filter; a solid support having one or more pores; and/or a fabric configured to allow fluid communication across the fabric while retaining edible material grinds. The mesh filter, solid support, and/or fabric may be used to prevent particulates from accumulating in a beverage produced by the beverage brewing device. For example, one or more filters may be incorporated into an internal compartment of a container of a beverage brewing device, wherein the internal compartment receives the rotor-stator assembly and edible materials to be ground. The mesh filter, solid support, and/or fabric may have pores with a pore size of 10 μm to 1,000 μm or any size within this range (e.g., 10 μm, 25 μm, 50 μm, 75 μm, 100 μm, 125 μm, 150 μm, 175 μm, 200 μm, 225 μm, 250 μm, 275 μm, 300 μm, 325 μm, 350 μm, 375 μm, 400 μm, 425 μm, 450 μm, 475 μm, 500 μm, 525 μm, 550 μm, 575 μm, 600 μm, 625 μm, 650 μm, 675 μm, 700 μm, 725 μm, 750 μm, 775 μm, 800 μm, 825 μm, 850 μm, 875 μm, 900 μm, 925 μm, 950 μm, 975 μm, or 1,000 μm. In some aspects one or more filters incorporated into a beverage brewing device or a pod may have a pore size ranging from: 10-50 μm, 10-100 μm, 10-250 μm, 10-500 μm, 20-60 μm, 30-70 μm, 40-80 μm, 50-90 μm, 60-100 μm, 100-200 μm, 200-300 μm, 300-400 μm, 400-500 μm, 500-600 μm, 600-700 μm, 700-800 μm, 800-900 μm, 900-1,000 μm, or a size range bounded by a combination of any two endpoints selected from the preceding size ranges. In some aspects, any combination or arrangement of filter densities may be selected for the top, bottom and sidewall(s) of a pod, or any portions thereof. Similarly, one or more filters may be incorporated into a beverage brewing device (e.g., in the container, housing, or rotor-stator assembly) which have a pore size within any of the preceding sizes ranges, or pore size equal to any of the preceding values or endpoints of such ranges.

Additional aspects of the disclosure include methods of brewing a beverage, and in particular methods of brewing a coffee beverage. A method of brewing a beverage may comprise, for example: placing an edible material in a rotor-stator assembly in a beverage brewing device (or any of the pods) described herein; submerging the rotor-stator assembly in a liquid, wherein the liquid is sufficient to fully or partially submerge the edible material; grinding the edible material using the rotor-stator assembly; and generating a beverage by steeping the ground-up edible material(s) in the liquid. In some implementations, the edible material may comprise a plurality of coffee beans that may be ground and used to brew a coffee beverage alone or in combination with one or more additional edible materials (e.g., flavoring agents or enhancers, nutritional or dietary supplements, meal replacement components, fruit). In some aspects, the ground-up coffee is steeped for less than 5, 10, 15, 20, 25 or 30 minutes, or steeped for a range of time (e.g., 1-5 minutes, 5-10 minutes, 10-20 minutes or any combination of minimum and maximum values within these ranges). In some aspects, the ground-up coffee may be steeped at a temperature of 0-25° C., 80-100° C., or at any temperature within the range of 0-100° C. suitable for producing a given beverage.

Another exemplary method of brewing a coffee beverage may comprise, for example: placing an amount of coffee beans in any rotor-stator assembly described herein (which may optionally be located within a pod); placing the rotor-stator assembly in fluid communication with a container; adding hot or cold water to the container; at least partially submerging the rotor-stator assembly in at least a portion of the hot or cold water that was in the container; generating coffee grinds by grinding the coffee beans using the rotor-stator assembly, wherein the grinding is optionally subject to one or more parameters (e.g., rotor configuration, grinding time, steeping temperature/time); and steeping the coffee grinds in the hot or cold water. In some aspects, the rotor-stator assembly may be located in any housing or pod described herein. The approximate amount of coffee beans placed in the rotor-stator assembly (or in a housing containing the rotor-stator assembly) may be, for example, any one of the following: 20 g, 5-20 g, 10-30 g, 15-40 g, 20-50 g or >50 g. In some aspects of the brewing methods described herein, the rotor-stator assembly may be attached to a support framework (e.g., a scaffold) prior to placing the pod in the container, wherein the support framework is attached to an upper surface or a lower surface of the rotor-stator assembly. Alternatively, in some aspects the rotor-stator assembly may be located in a pod according to the disclosure, which is in turn attached to a support framework. In some implementations, the volume of water added to the container is: 100-200 mL, 201-300 mL, 301-400 mL, 401-500 mL or >500 mL.

In still further aspects, methods of brewing coffee using any of the brewing devices disclosed herein are provided. For example, an exemplary method of brewing coffee may include providing a coffee brewing device comprising: a first container, having a top end and a bottom end; a second container adapted to attach to the bottom end of the first container, comprising a rotor-stator assembly and a filter; wherein the rotor-stator assembly is positioned within the second container; and a base adapted to attach to the bottom end of the first container, comprising a motor configured to operate the rotor-stator assembly; placing a plurality of coffee beans within the rotor-stator assembly in the second container; adding liquid to the first container sufficient to fully or partially submerge the coffee beans in the second container; and generating coffee by grinding the coffee beans using the rotor-stator assembly and allowing soluble and/or extractable components of the coffee beans to dissolve or form an emulsion in the liquid.

In other aspects, methods of brewing coffee include providing a coffee brewing device according to any of the various configurations described herein, adding sufficient liquid to a container of the device to fully or partially submerge the coffee beans, generating coffee by wet-grinding the coffee beans using a rotor-stator assembly positioned within the device, and allowing extractable components of the coffee beans to dissolve or form an emulsion in the liquid. In some aspects, the coffee beans are fully submerged throughout the grinding process. In some aspects, the liquid added to the container is at least: 0° C. to 100° C., 0° C. to 20° C. or 80° C. to 100° C., when added to the container. In some aspects, the edible materials may be ground for up to (or at least) 1-5 minutes, 5-10 minutes, 10-15 minutes, 15-20 minutes. In some aspects, the edible materials are subjected to grinding for up to (or at least) 1, 2, 3, 4, 5, 6, 7, 8, 9, 10, 11, 12, 13, 14, 15, 20, 25, or 30 minutes. In some aspects, the extractable components of the coffee beans are allowed to dissolve or form an emulsion in the liquid over a period of up to (or at least): 1 to 5 minutes, 5 to 10 minutes, 10 to 20 minutes, 20 to 30 minutes, 30 to 90 minutes, or longer.

In some aspects, the disclosure provides a method of brewing coffee, comprising: providing a coffee brewing device comprising a first container, having a top end and a bottom end; a second container adapted to attach to the bottom end of the first container, comprising a rotor-stator assembly and a filter; wherein the rotor-stator assembly is positioned within the second container; and a base adapted to attach to the bottom end of the first container, comprising a motor configured to operate the rotor-stator assembly; placing a plurality of coffee beans within the second container; adding liquid to the first container sufficient to fully or partially submerge the coffee beans in the second container; and generating coffee by grinding the submerged coffee beans and allowing soluble and/or extractable components of the coffee beans to dissolve or form an emulsion in the liquid. In further aspects, the liquid added to the container is at least 0-100° C., 0-20° C., or 80-100° C. when added to the container. In some aspects, the edible materials are subjected to grinding for up to (or at least) 1, 2, 3, 4, 5, 6, 7, 8, 9, 10, 11, 12, 13, 14, 15, 20, 25, or 30 minutes. In some aspects, the extractable components of the coffee beans are allowed to dissolve or form an emulsion in the liquid over a period of up to (or at least): 1 to 5 minutes, 5 to 10 minutes, 10 to 20 minutes, 20 to 30 minutes, 30 to 90 minutes, or longer.

In still further aspects, the disclosure provides a method of brewing coffee comprising at least partially submerging coffee beans in container comprising water, wherein there is an approximately 6% w/v ratio of coffee beans to water; and grinding the coffee beans using a rotor-stator assembly to obtain coffee, wherein the coffee comprises at least 0.25% total fat, at least 0.1% saturated fat, at least 0.1% polyunsaturated fat, at least 140 mg/100 ml polyphenol content, at least 65 mg/100 ml caffeine content, a substantially brown color, and/or a particulate concentration of ≤10 mg/mL. In other aspects, the ratio of coffee beans to water are at a ratio other than 6% but the relationship of the ratio to total fat, saturated fat, polyunsaturated fat, polyphenol content, caffeine content, and/or a particulate concentration remains linear. In other aspects, the water has a temperature of 0 to 25° C., the coffee is brewed within 15, or the water has a temperature of 0 to 25° C. and the coffee is brewed within 15 minutes.

In some aspects, the one or more parameters of the brewing process may include, for example, but are not limited hereto: a motor rotation speed parameter, a grinding run time parameter; a temperature parameter and/or a post-grinding steeping time parameter. Additional parameters may include, for example, a rotor flute shape/type and a filter size (e.g., minimum or maximum aperture size). In some aspects, the grinding run time is up to (or at least) 1, 2, 3, 4, 5, 6, 7, 8, 9, 10, 11, 12, 13, 14, 15, 20, 25, or 30 minutes. In some aspects, the extractable components of the coffee beans are allowed to dissolve or form an emulsion in the liquid over a period of up to (or at least): 1 to 5 minutes, 5 to 10 minutes, 10 to 20 minutes, 20 to 30 minutes, 30 to 90 minutes, or longer. The coffee grinds may be steeped in hot or cold water, for example, for any one of the following durations of time: ≤5 minutes, 5-10 minutes, 10-20 minutes, 20-30 minutes or ≥30 minutes. The temperature of the water added to the container is also variable and, for example, may fall within any of the following ranges: 0-5° C., 5-10° C., 10-20° C., 20-30, ° C., 30-50° C., 50-80° C. or 80-100° C. In any of the methods of making coffee described herein, the method may be performed using 6% w/v ratio of coffee beans or grounds to water.

In still further aspects, the disclosure provides various coffee compositions, such as coffee compositions prepared according to or with the methods, rotor-stator assemblies, and brewing devices described herein. Coffee compositions described herein may include, for example, one or more of the following: at least 0.25% total fat, at least 0.1% saturated fat, and/or at least 0.1% polyunsaturated fat. In some aspects, the coffee composition may have at least 0.10%, 0.15%, 0.20%, 0.30%, 0.35%, 0.40%, 0.45% or 0.50% total fat, or a total fat concentration within the range of 0.10-0.50%, 0.20-0.40%, 0.25-0.35%, or any combination of minimum and maximum values therein. In some aspects, the coffee composition may have at least 0.05%, 0.15%, 0.20%, 0.25%, 0.30%, 0.35%, 0.40%, 0.45% or 0.50% saturated fat, or a saturated fat concentration within the range of 0.05-0.50%, 0.1-0.40%, 0.15-0.35%, or any combination of minimum and maximum values therein. In some aspects, the coffee composition may have at least 0.05%, 0.15%, 0.20%, 0.25%, 0.30%, 0.35%, 0.40%, 0.45% or 0.50% polyunsaturated fat, or a polyunsaturated fat concentration within the range of 0.05-0.50%, 0.1-0.40%, 0.15-0.35%, or any combination of minimum and maximum values therein.

Coffee compositions produced using the methods and devices disclosed herein may have, for example, a polyphenol concentration of ≥100 mg/100 ml, ≥125 mg/100 ml, ≥150 mg/100 ml, 50-250 mg/100 ml, 100-200 mg/100 ml, 125-175 mg/100 ml, or any integer value within these ranges. In other aspects, the coffee composition has at least 65 mg/100 ml caffeine content. Coffee compositions produced using the methods and devices disclosed herein may also have, for example, a particulate concentration of ≤5 mg/mL, ≤6 mg/mL, ≤7 mg/mL, ≤10 mg/mL or a particulate concentration within the range of 3-7 mg/mL, 4-8 mg/mL, 3-9 mg/mL, 1-10 mg/mL, or any or any combination of minimum and maximum integer values within these ranges. In other aspects, the coffee composition, generated by coffee grounds, has been exposed to oxygen only at levels of <1%. In any of the coffee compositions described herein, the composition comprises coffee beans ground and brewed in water with an 6% w/v ratio of coffee beans or grounds to water.

Additional beverage brewing devices according to an aspect of the disclosure may include a first container, having a top end and a bottom end; a second container adapted to attach to the bottom end of the first container, comprising a rotor-stator assembly and a filter; wherein the rotor-stator assembly is positioned within the second container; and a base adapted to attach to the bottom end of the first container, comprising a motor configured to operate the rotor-stator assembly.

Beverage brewing devices according to another aspect of the disclosure may include, for example, a first container, having a top end and a bottom end; wherein at least a portion of the bottom end comprises a filter; a base adapted to attach to the bottom end of the first container, comprising a motor; and a second container comprising a top end, a bottom end, and a rotor-stator assembly positioned within the second container and configured to be operated by the motor; wherein the bottom end of the second container is adapted to attach to the base at a position. In some aspects, the base further comprises a power supply connected to the motor; or is connectable to an external power supply capable of powering the motor. In some aspects, the second container is a pod or canister, and/or the rotor-stator assembly which may be adapted to grind coffee beans. In some aspects, the filter comprises a metallic sieve having one or more openings adapted to allow a liquid to pass through the filter.

Beverage brewing devices according to another aspect of the disclosure may include, for example, a container, having an top end and a bottom end; a handle attached to an outside surface of the container and comprising a switch; a rotor-stator assembly, attached to an inside surface of the container at the bottom end; a repositionable filter attached to an inside surface of the container, configured to move into an open position or a closed position in response to operation of the switch; wherein the closed position prevents fluid communication between the container and the compartment; and a base adapted to attach to the bottom end of the container, comprising a motor configured to operate the rotor-stator assembly. In some aspects, the device further includes, for example, means for locking the filter in a closed position, wherein the means for locking is configured to unlock in response to operation of the switch. In some aspects, the repositionable filter is a mesh filter attached to the inside surface of the container by at least one hinge, and/or comprises a metallic sieve having one or more openings adapted to allow a liquid to pass through the filter. In some aspects, the rotor-stator assembly may be adapted to grind coffee beans. In some aspects, the base further comprises a power supply connected to the motor; or is connectable to an external power supply capable of powering the motor.

Beverage brewing devices according to another aspect of the disclosure may include, for example, a first container, having a top end and a bottom end; a second container, having a top end, a bottom end, and a side wall; wherein at least a portion of the side wall, the bottom end, and/or top end comprises a filter; a rotor-stator assembly, attached to the second container at the bottom end; a partition positioned within the second container, which defines an upper chamber and a lower chamber, wherein the lower chamber contains the rotor-stator assembly; and a base adapted to attach to the bottom end of the second container, comprising a motor configured to operate the rotor-stator assembly. In some aspects, the filter comprises a majority of the surface area of the second container. In some aspects, the partition is adapted to prevent suction of air into the rotor-stator assembly during operation of the rotor-stator assembly. In some aspects, the filter is structured as a cylinder or a conical cylinder. In other aspects, the filter comprises a metallic sieve having one or more openings adapted to allow a liquid to pass through the filter. In some aspects, the second container further comprises at least one attachment point configured to fasten or secure the filter in place. In some aspects, the base further comprises a power supply connected to the motor; or is connectable to an external power supply capable of powering the motor. In some aspects, the rotor-stator assembly may be adapted to grind coffee beans.

Beverage brewing devices according to another aspect of the disclosure may include a beverage brewing device, comprising: a container, having a top end and a bottom end; a support framework configured to fit within the container, comprising: an upper compartment having a top end, a bottom end, and a side wall, wherein at least a portion of the bottom end of the upper compartment comprises a filter, grating or valve and the sidewalls allow water to flow through into the container; a detachable lower compartment having a bottom end and a sidewall, wherein at least a portion of the bottom end and/or side wall comprises a filter; a rotor-stator assembly, attached to the lower compartment at the bottom end; and a base adapted to attach to the bottom end of the container, comprising a motor configured to operate the rotor-stator assembly. In some aspects, the beverage brewing device comprises a heating element integrated into the device. In other aspects, the heating element is integrated into a base, compartment or the container of the device, and/or the heating element is configured to heat and/or maintain the temperature of a liquid stored in the container or compartment of the device. In other aspects, the rotor component of the rotor-stator assembly comprises one or more of the following: one or more interchangeable flutes; one or more flutes adapted to provide simultaneous grinding and mixing; at least one flat flute and at least one bent or curved flute. In other aspects, the rotor comprises a pair of flutes extending outward to form a “U”-shape which are adapted to provide force to direct liquid through at least one filter of the device.

Details of one or more implementations of the subject matter described in this specification are set forth in the accompanying drawings and the description below. Other features, aspects, and advantages will become apparent from the description, the drawings, and the claims.

### BRIEF DESCRIPTION OF THE DRAWINGS

The accompanying drawings, which are incorporated into and constitute a part of this specification, illustrate one or more example aspects of the invention and, together with the detailed description, serve to explain their principles and implementations. In several of the figures, a hatched pattern is used to indicate the presence of a liquid within implementations of a beverage brewing devices according to the disclosure.

FIG. 1A is a partially-transparent perspective view of a rotor-stator assembly according to an aspect of the disclosure, wherein the rotor comprises two flutes with only one flute in any given horizontal plane. These two flutes are configured to counterbalance one another.

FIG. 1B is a partially-transparent perspective view of a rotor-stator assembly according to an aspect of the disclosure, wherein the rotor comprises three flutes.

FIG. 1C is a partially-transparent perspective view of a rotor-stator assembly according to an aspect of the disclosure, wherein the rotor comprises four flutes.

FIG. 2 is a partially-transparent perspective view of a rotor-stator assembly according to an aspect of the disclosure, wherein the rotor comprises two flutes which each include a vertically-extending portion.

FIG. 3 is a partially-transparent perspective view of a rotor-stator assembly according to an aspect of the disclosure, wherein the rotor comprises four flutes that each include an angular fin extending from the flute.

FIG. 4A is a partially-transparent perspective view of the rotor-stator assembly shown in FIG. 1A, with an attached baffle according to another aspect of the disclosure.

FIG. 4B is a partially-transparent perspective view of the rotor-stator assembly shown in FIG. 1A, with an attached baffle according to another aspect of the disclosure.

FIG. 5A is a perspective view of a rotor-stator assembly with the baffle shown in FIG. 4A, attached to a support framework.

FIG. 5B is a cross-sectional view of the perspective view shown in FIG. 5A.

FIG. 5C is a perspective view of a rotor-stator assembly with the baffle shown in FIG. 4B, attached to a support framework.

FIG. 5D is a cross-sectional view of the perspective view shown in FIG. 5C.

FIG. 6A is a perspective view of a partially-assembled beverage brewing device according to an aspect of the disclosure.

FIG. 6B is a cross-sectional view of the partially-assembled beverage brewing device shown in FIG. 6A.

FIG. 7A is a partially-transparent front view of a portion of a beverage brewing device according to an aspect of the disclosure, depicting a pumping rotor-stator assembly situated within the device.

FIG. 7B is a cross-sectional view of the device shown in FIG. 7A.

FIG. 8A is a perspective view of a rotor-stator assembly affixed to a portion of a beverage brewing device, wherein the rotor-stator assembly includes fins partially-enclosed within a housing.

FIG. 8B is a version of the perspective view shown in FIG. 8A, wherein the housing is partially transparent.

FIG. 8C is a version of the perspective view shown in FIG. 8A, wherein the housing and stator are partially transparent.

FIG. 8D is a perspective view of the rotor-stator assembly affixed to a portion of a beverage brewing device shown in FIG. 8A, without the housing and stator components.

FIG. 9 is a perspective view of rotor according to an exemplary aspect, shown attached to an axle.

FIG. 10A is a perspective view of the rotor shown in FIG. 9.

FIG. 10B is a top view of the rotor shown in FIG. 10B.

### DETAILED DESCRIPTION

The disclosure provides devices and methods for efficiently producing beverages having improved properties compared to traditional brewing methods. In general, these devices provide an all-in-one grinding and brewing system that grinds edible material (e.g., coffee beans) or combinations of edible materials (e.g., coffee beans and one or more edible additives or flavorants such as cinnamon sticks, chocolate or spices) submerged or partially submerged in a liquid, using a rotor-stator assembly. It is understood that any edible material capable of being ground and brewed to form a beverage may be used. These devices and components thereof are provided herein, as well as methods of brewing beverages, and beverages obtained are provided.

Conventional drip-based coffee brewing at high temperatures is used to quickly brew a cup of coffee. However, drip-based methods typically fail to extract poorly soluble coffee compounds (e.g., fats, fatty acids and other compounds), and consequently fail to produce coffee having these compounds. On the other hand, French press methods are capable of extracting a small portion of the oil contained in the coffee beans but require high heat which may negatively impact the flavor of the coffee, and also require substantial manual preparation by the user (a user must grind beans, heat water, mix the grinds and water, and filter the resulting coffee beverage). Cold brew methods typically fail to extract a substantial amount of the oil and other poorly soluble (or extractable) compounds in coffee and also require a sizable investment of time, e.g., 12-16 hours. None of these existing devices or methods provides fast brewing, high oil extraction and the option to completely avoid heat damage.

Surprisingly, the present disclosure provides brewing methods and devices capable of producing coffee having an extraction profile similar to or better than known methods, quickly and optionally without heat damage. A summary of selected differences between known coffee brewing methods and methods according to the present disclosure (“HydroGrind Plus”) is provided by Table 1 below. Relative differences in properties or requirements are denoted by one or more “+” (positive) or “X” (negative) symbols. With respect to “dissolved content,” caffeine and anti-oxidant content were selected as representative proxies for evaluating this parameter.

TABLE 1
Relative Advantages of HydroGrind Plus Coffee.

| | | | | | | | No | Low |
|---|---|---|---|---|---|---|---|---|
| | Oil | Dissolved | No Heat | Prep and | Brew | Serial Cup | Oxygen | Particulate |
| Method | Content | Content | Damage | Clean Time | Time | Serving | Exposure | Count |
| Drip | X | + | X | + | + | + | X | +++ |
| French | ++ | ++ | X | X | + | X | X | + |
| Press | | | | | | | | |
| Cold Brew | + | + | + | + | XXX | + | X | +++ |
| HydroGrind | +++++ | +++ | + | + | + | + | + | + |
| Plus | | | | | | | | |

As illustrated by Table 1, coffee produced using aspects of the present disclosure may have one or more improvements or benefits compared to coffee produced using traditional methods. For example, it may have a higher oil content (substantially higher in some cases), a higher amount of dissolved content extracted from the coffee grinds (e.g., caffeine and antioxidants), and a lower particulate count. The present devices and methods are also advantageous in that they allow one to produce coffee quickly (e.g., due to reduced preparation, brewing, and clean-up time requirements), without exposing the coffee grinds to oxygen. Users also have the option of performing the disclosed methods at a low temperature, avoiding heat damage, without the lengthy time requirements associated with traditional cold brew methods.

The present disclosure provides methods of brewing coffee from whole coffee beans without any further intervention by the user (e.g., there is no need to grind beans separately, heat water, or filter the particulates). Relatively low particulate count is enabled by the use of a rotor-stator assembly and/or by the use of filters. The devices and methods also enable a wide variety of coffee flavors, brew intensities and temperatures by allowing easy user interfaces. The user can create a very wide variety of coffee flavors and textures by changing the grinding time, grinding speed, water temperature and rotor. The devices and methods also allow ease of cleaning since a majority of insoluble/non-extractable material is confined to the easy-to-handle rotor-stator assembly (and optionally within a pod in some implementations).

Various aspects are now described with reference to the drawings, wherein like reference numerals are used to refer to like elements throughout the description that follows. In this description, for purposes of explanation, numerous specific details are set forth in order to promote a thorough understanding of one or more aspects. It may be evident in some or all instances, however, that any aspect described below can be practiced without adopting the specific design details described below. The following presents a simplified summary of one or more aspects in order to provide a basic understanding of the aspects. This summary is not an extensive overview of all contemplated aspects, and is not intended to identify key or critical elements of all aspects nor delineate the scope of any or all aspects.

Rotor-Stator Assemblies and Related Components

The present disclosure provides various beverage brewing devices and methods, and in particular devices and methods for brewing coffee. The devices use a rotor-stator assembly. Rotor-stator assemblies comprise a rotatable shaft with at least one flute extending from the shaft (the “rotor”), positioned within a stationary casing dotted with one or more holes (the “stator”). Rotor-stator assemblies are used in the preparation of liquid emulsions (e.g., a mixture of two immiscible liquids) in which one liquid (the dispersed phase) is distributed in the form of microscopic droplets in the other (continuous) phase. During the emulsification process, the rotation of the rotor creates a suction effect that draws liquid into the space between the rotor and the stator, in which it is subject to high shear forces due to the extreme change in velocity in the small gap between the rotor and stator. Centrifugal forces proceed to push the liquid outward through slots in the stator, creating microscopic droplets of the dispersed liquid in the continuous liquid.

Surprisingly, the present disclosure provides rotor-stator assemblies capable of producing a beverage from solid edible materials, which are ground by the rotor-stator assembly while wholly or partially-submerged in a liquid. In some aspects, these rotor-stator assemblies may be used to brew coffee having an extraction profile similar to or better than known methods, quickly and optionally without heat damage.

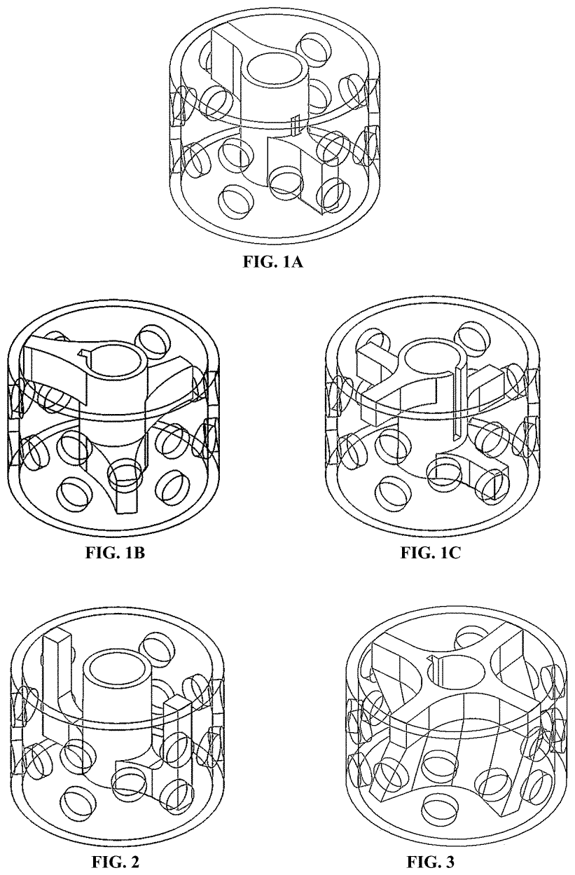

A rotor-stator assembly according to the disclosure may comprise a rotor having at least one flute extending outward from the shaft. In some aspects, a flute extends solely along a horizontal axis. A flute may also extend upwards or downwards along a vertical axis (e.g., to form an “L”-shape as illustrated by the rotor shown in FIG. 2). However, more complex shapes are possible (e.g., a flute may bend or curve along any axis as it extends from the shaft into any arbitrary shape suitable to grind an edible material). A flute may be formed as a projection that gradually tapers as it extends outward from the shaft. The distal portion of a flute may terminate in a blunt end as illustrated by the exemplary rotors shown, e.g., in FIGS. 1A-1C. In some aspects, a rotor may comprise multiple flutes wherein two or more (or all) of the flutes have an identical shape. In other aspects, a rotor may comprise multiple flutes, each having a unique shape. In further aspects, a rotor may comprise multiple flutes wherein two or more of the flutes are formed are symmetrical.

As shown by FIG. 3, flutes may incorporate angular or curved portions that extend across at least a portion of the length of the stator along the axis of rotation of the rotor. These “fins” form a surface configured to manipulate the flow of liquid entering and exiting the stator. The rotor shown in this example comprises four flutes extending outward from the central shaft at the same position along the axis of rotation, with curved fins shown extending across the entire length of the stator along the axis of rotation of the rotor. Fins may be incorporated into a rotor to encourage or discourage vortex formation or turbulence. The placement, size, shape and curvature of a fin (or set of fins) may be adjusted as desired to optimize grinding and/or mixing a particular beverage. For example, the curvature (e.g., clockwise or counter-clockwise) of the one or more fins may be selected to match or oppose the direction of rotation of the rotor, potentially mitigating vortex formation.

In some aspects, it may be advantageous to wholly or partially counterbalance the one or more flutes of the rotor. The counterbalancing element may comprise one or more portions extending outward from the shaft. In some aspects, the counterbalancing element may comprise a portion of the shaft opposite to the flute. The counterbalancing element may comprise, e.g., a lateral extension of the shaft comprising the same or a denser material than the material used to form the corresponding flute. For example, if a single flute is used, the rotor shaft may include a counterbalancing element at a position 180° opposite from the flute. If a plurality of flutes is used, it may be possible to orient the flutes to provide a counterbalance (a pair of flutes may be spaced apart by 180°, a set of three flutes may be spaced apart by 120°, a set of four flutes may be spaced apart by 90°, etc.). In some aspects, the plurality of flutes may be oriented along the shaft such that each flute is offset along the plane of the axis of rotation, with no two flutes extending from the same portion of the shaft (e.g., as illustrated by the rotors shown in FIGS. 1A-1C).

In some aspects, it may be advantageous to adapt a rotor-stator assembly to accommodate large edible materials. For example, in the case of a circular stator with a central axle and a four-flute rotor (with all flutes positioned in the same horizontal plane), edible materials must have a unit size sufficient to fit within a quadrant of the rotor-stator assembly. In some aspects, a stator used in the devices or methods described herein may have a cross-sectional diameter of 2.0 cm, 2.5 cm, 3.0 cm, 3.5 cm, 4.0 cm, 4.5 cm, 5.0 cm, 5.5 cm, 6.0 cm, 6.5 cm, 7.0 cm, 7.5 cm, 8.0 cm, 8.5 cm, 9.0 cm, 9.5 cm, 10.0 cm, or a diameter within a range having endpoints selected from any combination of these sizes. In some aspects, the stator may have a larger cross-sectional diameter (e.g., scaled up for high-volume or industrial level brewing).

In practice, the additional thickness of the flutes and the casing of the stator will further reduce the horizontal cross-sectional area addressable for grinding. Rotors according to some aspects of the disclosure, with flutes oriented at different positions along the plane of the shaft, address this issue by increasing the horizontal cross-sectional area addressable for grinding. Such configurations may allow for the grinding of relatively large edible materials using a grinder powered by a typical household circuit (e.g., 15 or 20 amps).

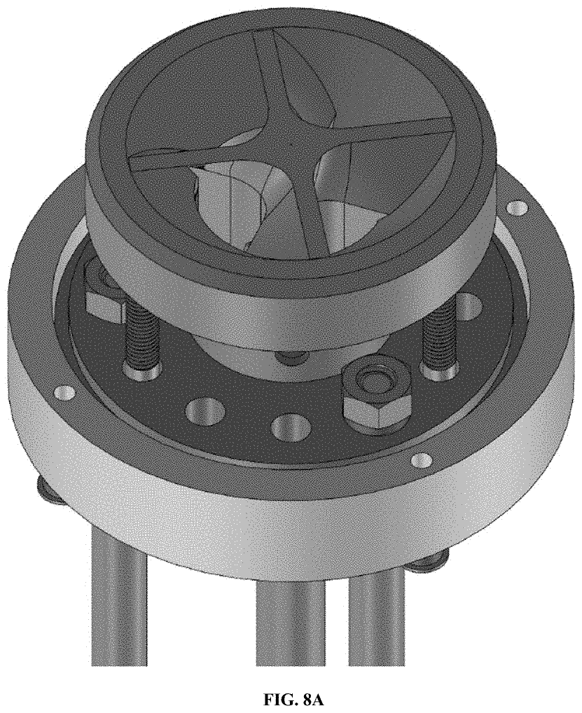

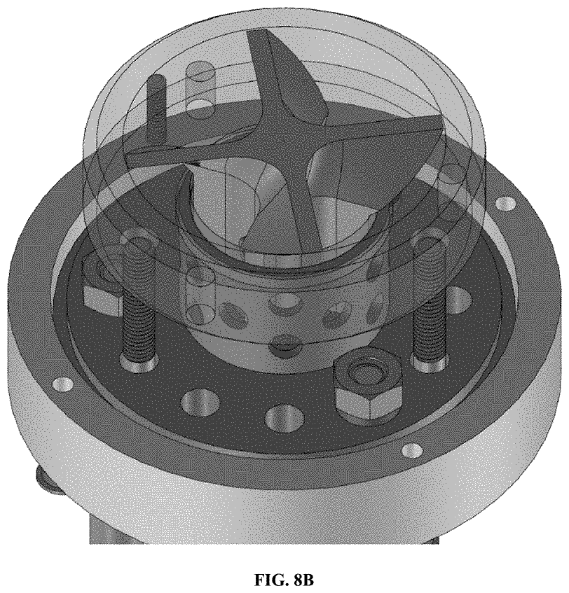

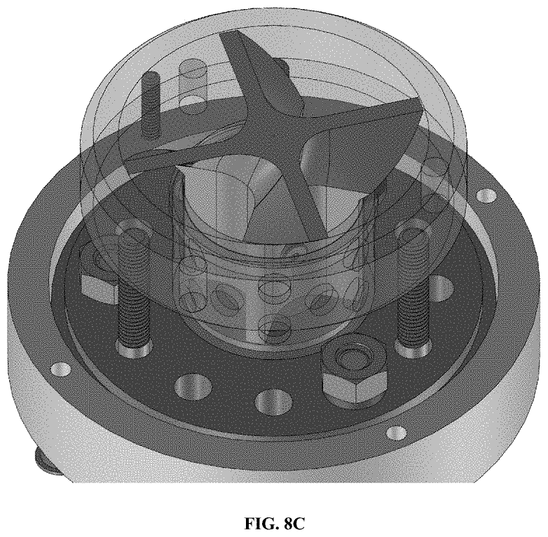

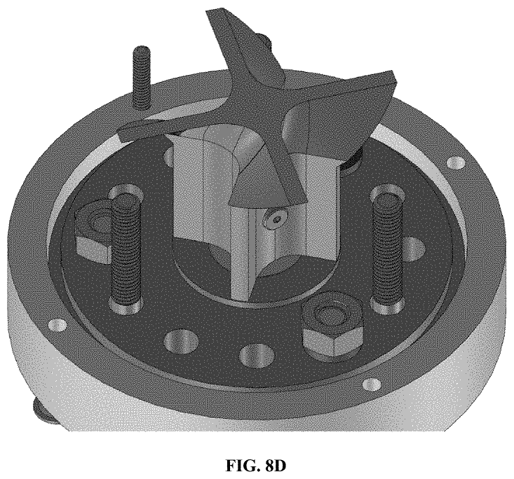

Alternatively, devices and methods with an improved capability to grind larger edible materials may be constructed by increasing the size of the rotor-stator assembly and increasing the pumping force to bring in large edible materials. Optionally, a rotor-stator assembly may also include additional components adapted to direct the flow of edible materials into the rotor-stator assembly (e.g., fins, optionally with an additional housing), as depicted by FIGS. 8A-8D.

In some aspects, a rotor-stator assembly according to the disclosure comprises a stator which includes one or more openings or slots in its casing. As illustrated, e.g., by FIGS. 1-3, the one or more openings may comprise a plurality of circular holes. However, any shape may be used (e.g., circular, square, elliptical or other shapes). For example, the one or more openings in the stator may have a diameter of approximately (or exactly) 0.25 mm, 0.50 mm. 0.75 mm, 1.00 mm, 1.25 mm, 1.50 mm, 1.75 mm, 2.00 mm, 2.25 mm, 2.50 mm, 2.75 mm, 3.00 mm, 3.25 mm, 3.50 mm, 3.75 mm, 4.00 mm, 4.25 mm, 4.50 mm, 4.75 mm, 5.00 mm, 5.25 mm, 5.50 mm, 5.75 mm, 6.00 mm, 6.25 mm, 6.50 mm, 6.75 mm, 7.00, 7.25 mm, 7.50 mm, 7.75 mm, 8.00 mm, 8.25 mm, 8.50 mm, 8.75 mm, 9.00 mm, 9.25 mm, 9.50 mm, 9.75 mm, or 10.00. In some aspects, the or more openings in the stator may have a diameter in the range of 0.01-0.50 mm, 0.50-1.00 mm, 1.00-1.50 mm, 1.50-2.00 mm, 2.00-2.50 mm, 2.50-3.00 mm, 3.00-3.50 mm, 3.50-4.00 mm, 4.00-4.50 mm, 4.50-5.00 mm, 5.00-5.50 mm, 5.50-6.00, 6.00-6.50 mm, 6.50-7.00 mm, or a range bounded by a combination of any two endpoints selected from the preceding ranges. In aspects where the one or more openings are asymmetric or irregularly-shaped openings (e.g., elliptical holes), the aforementioned diameter sizes and ranges may refer to a diameter across the widest portion. The rotor-stator assembly may be sized to hold a desired amount of an edible material to be ground by the device. For example, a rotor-stator assembly may be sized to hold 1-10 g, 10-20 g, 20-30 g, 30-40 g, 40-50 g, or any integer value or subrange within 1-50 g, of coffee beans or any other edible materials. In some aspects, a rotor-stator assembly according to the disclosure may be sized to accommodate a larger amount of edible materials (e.g. >50 g), whether for industrial, small business, commercial or other purposes.

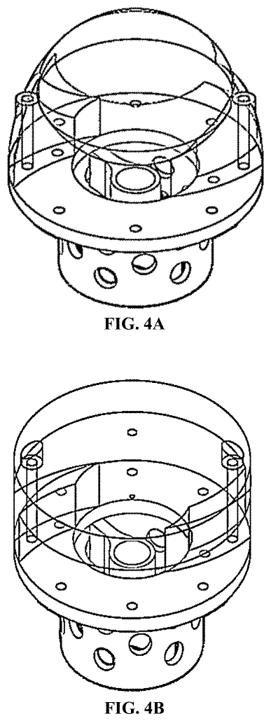

A rotor-stator assembly according to the disclosure may further comprise an optional baffle. This baffle component may be adapted to disrupt the flow of liquid containing edible materials during the grinding process, or more specifically, to prevent or reduce vortex formation. In some aspects, the baffle may be adapted to provide sufficient space for the flow of edible materials in the liquid to enter the stator while preventing a vortex or substantial amounts of air to enter the rotor stator system and the grinding process. As illustrated by FIGS. 4A and 4B, the baffle may comprise a flat or curved element placed above the stator which obstructs the vertical flow of liquid exiting the rotor-stator assembly. In other aspects, the baffle may be oriented below the rotor-stator assembly. The baffle may be constructed in any shape sufficient to at least partially disrupt the flow of liquid entering or exiting the rotor-stator assembly. In some aspects, the baffle comprises at least one surface that substantially blocks the vertical flow of liquid entering or exiting the rotor-stator assembly. In other aspects, the baffle may regulate the flow of liquid, e.g., by diverting the flow of liquid towards a horizontal direction. A baffle may be constructed as an integral portion of the stator or as a separate element that may be attached, directly or indirectly, to the stator. In some aspects, the baffle may be attached (or attachable) to the stator or held in place by an intervening support structure or framework (e.g., comprising one or more struts). In some aspects, a surface of the stator and a surface of the baffle may have corresponding threading which allows the baffle to be fastened onto the stator (e.g., affixed by rotation to provide a cap-like structure over the stator).

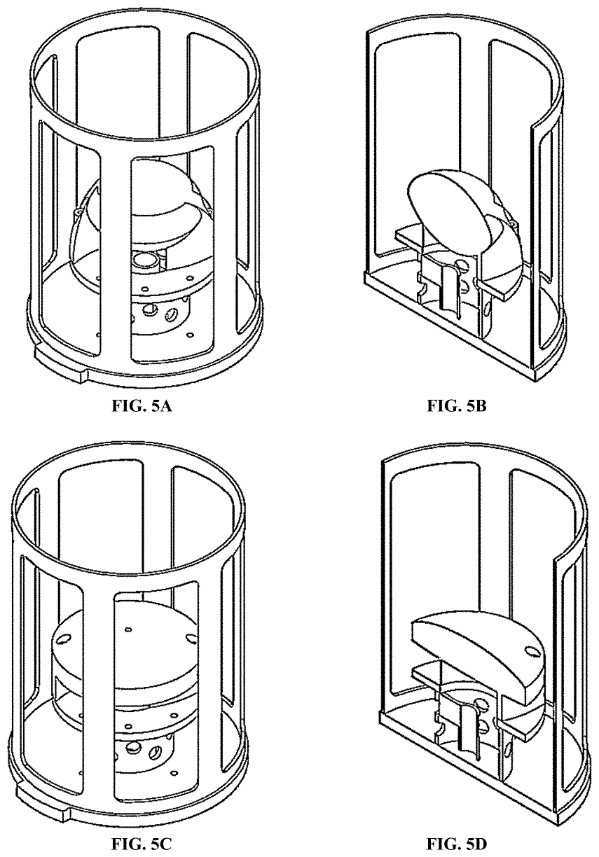

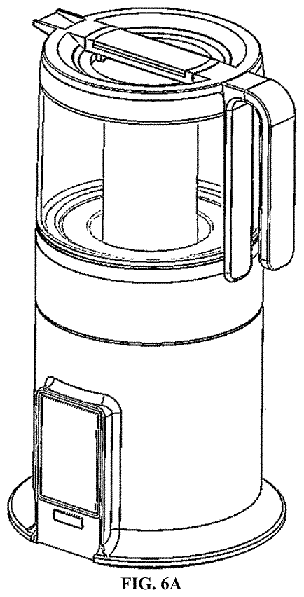

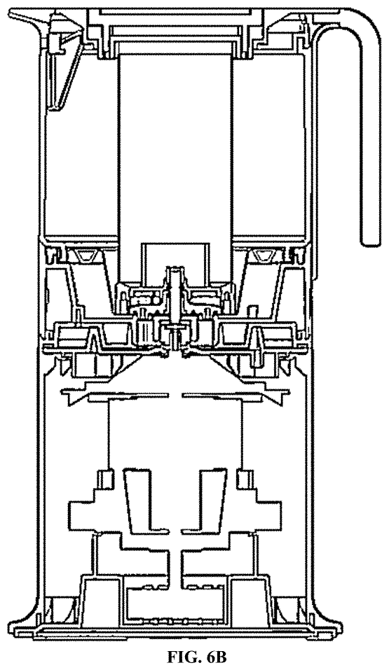

The rotor-stator assembly may be attached (or attachable) to a surface, framework, or other support structure. FIGS. 5A-5D illustrate exemplary aspects where the rotor-stator assembly is attached to a flat surface positioned below the assembly. This surface forms a circular base for the assembly. Several vertical struts extend upward from the surface and connect to form a cage-like framework. In other aspects, rotor-stator assembly may be attached (or attachable) to a surface or other support structure positioned above or laterally adjacent to the assembly. In some aspects, a rotor-stator assembly may be attached to multiple surfaces and/or support structures, directly or via one or more intervening structural elements. In some aspects, the rotor-stator assembly is attached to a support structure adapted to fit within a housing that forms a container or chamber enclosing the rotor-stator assembly. In other aspects, the housing may only partially enclose the rotor-stator assembly. FIGS. 5B and 5D do not illustrate a hole in the flat surface positioned below the rotor-stator assembly. However, it is understood that these are simplified illustrations and that, in practice, this configuration would typically include an axle extending through a hole in the flat surface (e.g., wherein the axle is rotated by operation of a motor).

The rotor-stator assembly and any other components of a beverage brewing device according to the disclosure may be constructed using any materials suitable for a given implementation (e.g., metallic, plastic, glass, or composite materials). In some aspects, at least a portion of the rotor and/or stator may be constructed from steel, iron, or aluminum. In some aspects, suitable materials used to construct these elements may comprise heat or rust-resistant materials (e.g., stainless steel). The material(s) used to construct the rotor may be selected based upon the hardness of the edible materials to be ground by the beverage brewing device. Additional components that may be incorporated into a beverage brewing device according to the disclosure (a housing, baffle(s), internal or external structural components, etc.) may be similarly constructed using any of the materials described herein.

Grinding Pods

The present disclosure provides various beverage brewing devices and methods, and in particular devices and methods for brewing coffee. Some of the devices described herein use a grinding pod (in some contexts abbreviated as a “pod” or referred to more generally as a “container”) that may be attached to or inserted into another container that functions as a water reservoir. Pods may be structured, in some non-limiting examples, as a container, capsule, chamber, compartment or other enclosed vessel wherein at least one surface comprise a filter allowing liquid communication. Although pods are often described in the devices and methods herein to provide additional context, it is understood that the pods themselves are also implementations of the present disclosure.

In some aspects, a pod adapted for use with a beverage brewing device may comprise: an upper wall; a lower wall; one or more side walls connecting the upper wall and the lower wall to form a compartment; a rotor-stator assembly attached to an inner surface of the compartment and adapted to grind an edible material; wherein at least a portion of the upper wall, the lower wall, or the one or more side walls comprises a filter adapted to allow fluid communication through the pod. The rotor-stator assembly may be adapted to grind coffee beans.

One or more of the pod filters may be detachable or adjustable into an open or closed configuration (e.g., by a hinge or clasp). The pod may be a capsule or canister, or in some implementations an enclosed compartment formed from a support framework. The outer surface of the pod may be adapted to attach to a surface of a container, wherein the container comprises one or more of a fluid reservoir, a motor configured to drive the rotor-stator assembly, a switch configured to activate the rotor-stator assembly, and/or a power supply configured to power the rotor-stator assembly. In still further implementations, one or more of these components may be located instead on a base configured to attach to the container during operation of a beverage brewing device.

In some aspects, the grinding pod is adapted to attach to the inside of a container which stores the brewing liquid in a manner that allows the pod to be switched between a closed state which blocks fluid communication between the container and the pod (e.g., preventing or stopping the steeping process) and an open state allowing fluid communication between the container and the pod (e.g., allowing steeping to begin or continue). For example, the pod may be adapted to rotate between two configurations when attached, which open or block one or more openings in a side wall or other surface of the grinding pod. Configurations which incorporate this feature advantageously allow a user to store the grinding pod in the brewing device after brewing is complete by switching the pod to the closed position, providing convenient storage for the pod without over-steeping the brewed beverage.

The rotor-stator assembly within the pod may comprise any combination of structural features and/or parameters of any of the rotor-stator assemblies described herein. The number, thickness and/or the angle of the rotor flutes may be adapted to grind edible material(s) (e.g., coffee beans) to a selected minimum, maximum or average particle size.

Beverage Brewing Devices

FIGS. 6A and 6B illustrate a beverage brewing device according to an aspect of the disclosure. As shown by this example, a beverage brewing device may comprise a housing 601, and a container 602 adapted to hold a liquid and to receive a beverage generated by a rotor-stator assembly 603 capable of grinding edible materials.

The container 602 may have an internal compartment 607 defined by one or more surfaces (e.g., side walls), wherein fluid communication between the internal compartment 607 and the rest of the container 602 is restricted or controlled. For example, fluid communication may only be allowed to proceed through one or more filters 609 located in the surface of the internal compartment 607. The internal compartment 607 may be adapted to receive the rotor-stator assembly 603 and/or the edible materials to be ground by the rotor-stator assembly 603. This internal compartment 607 may be further adapted to retain grinds produced by the grinder (e.g., the one or more filters may function as a sieve, retaining grounds in the internal compartment 607 during the grinding process while the resulting beverage is allowed to freely circulate throughout the container 602. It is understood that a container 602 (or an internal compartment 607 thereof) may be adapted to receive any of the various rotor-stator assemblies 603 described herein, whether alone or attached to a framework 604. The container 602 may be adapted to receive, contact, or connect to the housing 601. In some aspects, a container 602 may be adapted to securely attach to a housing 601. For example, the container 602 and the housing 601 may have complementary surfaces that can be securely fit together by a user (e.g., a locking mechanism triggered by rotating a surface of the container 602 against a corresponding surface of the housing 601). One or more filters 609 may be incorporated into the container 601 (e.g., as part of a surface of the internal compartment 607).

The housing 601 may comprise any structure suitable to contain a motor 605 capable of driving the rotor of the rotor-stator assembly 603. In some aspects, the housing 601 may comprise a power supply 611 and/or an interface to control the rotor-stator assembly 603, and/or one or more heating elements 610 configured to heat a liquid stored in the container 602 when the container 602 is attached to the housing 601.

The rotor-stator assembly within the pod may comprise any combination of structural features and/or parameters of any of the rotor-stator assemblies described herein.

A partially-assembled beverage brewing device 600 is shown in FIGS. 6A and 6B. When fully-assembled, this exemplary beverage brewing device 600 comprises three main sections: a housing 601, a container 602, and a rotor-stator assembly 603 (optionally attached to a framework 604). FIGS. 6A and 6B depict the housing 601 attached to the container 602, excluding the rotor-stator assembly 603. However, it is understood that the device may be configured to accommodate any rotor-stator assembly according to the disclosure (e.g., any of the rotor-stator assemblies shown in FIG. 4A, 4B, or 5A-D).

In this exemplary aspect, the housing 601 includes a motor 604 (shown in the cross-section of FIG. 6B) capable of operating the rotor-stator assembly 603. This housing 601 may also include a power supply 611 (not shown). The outer surface of the housing may comprise an interface 606 (shown in FIG. 6A) that allows a user to control the beverage brewing device 600, or any of the components thereof (e.g., the motor 605). The upper surface of the housing 601 may be adapted to interface with or attach to the container 602. For example, this upper surface may have a shape that is complementary to a corresponding lower surface of the container 602, allowing these elements to fit together securely. In some aspects, the container 602 may be configured to attach to the upper surface of the housing 601 upon rotation of the container 602 against the upper surface of the housing 601. The housing 601 may comprise one or more heating elements 610. In this example, a ring-shaped heating element 610 is incorporated into the upper surface of the housing 601. The heating element 610 is thus placed into contact with the lower surface of the container 602 when the container 602 is attached to the housing 601 (e.g., allowing the heating element 610 to heat liquid stored in the container 602). In this example, the upper surface of the housing 601 is shown to have a raised portion along the rim and a recessed area in the center. This configuration causes liquid in the container 602 to collect in the center of the upper surface when the beverage brewing device 600 is fully assembled. This configuration is advantageous in some embodiments, as it allows for the rotor-stator assembly 603 to be fully submerged in a lower volume of liquid when the beverage brewing device 600 is fully assembled.

In some exemplary aspects, the rotor-stator assembly 603 may be attached to an interface (e.g., an axle) located on the upper surface of the housing 601, wherein the interface is configured to allow a motor 605 in the housing 601 to drive the rotor of the rotor-stator assembly 603. In some aspects, the rotor-stator assembly 603 is attached to the housing 601 in a recessed area located in the center of the upper surface of the housing 601. In some aspects, the rotor-stator assembly 603 is integrally attached to a surface of the housing 601. In some aspects, the rotor-stator assembly 603 may instead be detachable (e.g., the housing 601 may be adapted to attach to a plurality of different rotor-stator assembly 603 configurations, allowing a user to select and attach different rotor-stator assembly 603 configurations suitable for different edible materials).

As shown by FIGS. 6A and 6B, the container 601 may include an internal compartment 607 capable of (or adapted to) receive the rotor-stator assembly 603. In some aspects, the internal compartment 607 may be configured to receive the edible materials to be ground by the beverage brewing device 600 and to retain the grinds resulting from such materials. In this example, a cylindrical internal compartment 607 is shown in the center of the container 601, extending vertically from the upper surface of the container 601. The surface of the internal compartment 607 may comprise one or more filters 609 (e.g., a mesh filter; a solid support having one or more pores; and/or a fabric configured to allow fluid communication across the fabric while retaining edible material grinds). For example, the internal compartment 607 may comprise a cylindrical sidewall having one or more sections that comprise a mesh filter. In some exemplary aspects, the entire surface of the internal compartment 607 may comprise a filter 609. In this example, the internal compartment 607 is adapted to receive a rotor-stator assembly 603 attached to a cylindrical framework 604 (e.g., as shown in FIGS. 5A-5D).

A user may begin assembling the beverage brewing device 600 shown in FIGS. 6A-6B by attaching a rotor-stator assembly 603 (not shown) to the surface of the housing 601. Afterward, the user may proceed to attach the container 602 to the housing 601. This may be accomplished by placing the lower surface of the container 602 into contact with the upper surface of the housing 601 and enabling (or triggering) a locking mechanism capable of securing these components together during the brewing process. In some aspects, this may be performed by rotating the container 602 to trigger a locking mechanism that causes these components to be held securely together (the container 602 may be detached from the housing 601 by rotating these elements in the opposite direction). The user may then remove the lid 608 of the container in order to gain access the internal compartment 607. In some exemplary aspects, the beverage brewing device 600 may also be configured to allow a user to attach (or detach) the rotor-stator assembly 603 at this point (e.g., by lowering the rotor-stator assembly 603 (and optional framework 604) into the internal compartment 607 and attaching it to a corresponding interface (e.g., an axle) on the upper surface of the housing 601, which allows the motor 605 to drive the rotor of the rotor-stator assembly 603.

The user may place a desired amount of edible materials (e.g., coffee beans) in the internal compartment 607, before or after adding a volume of liquid (e.g., water) to the container 602. As liquid is added, the container 602 will gradually fill. Once a sufficient volume of liquid has been added (e.g., enough to fully or partially submerge the rotor-stator assembly 603), the user may initiate brewing process by activating the rotor-stator assembly 603 (e.g., using the interface 606 provided on the housing 601). A beverage will begin to form in the container 602 as liquid circulates between the internal compartment 607 and the remainder of the container 602 through the one or more filters 609. As the grinding proceeds, components of the edible materials (e.g., coffee beans) are extracted by the circulating liquid (e.g., by dissolving into the liquid or forming an emulsion), and the liquid placed in the container 602 is gradually converted into a beverage (e.g., coffee).

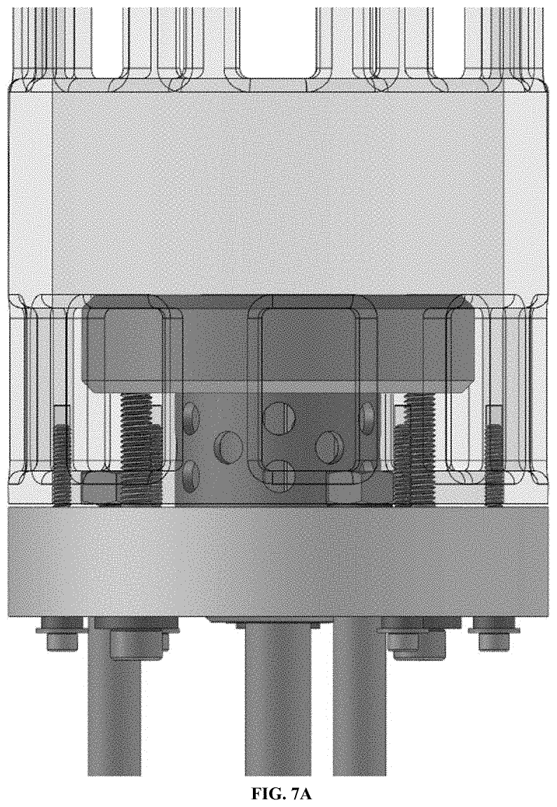

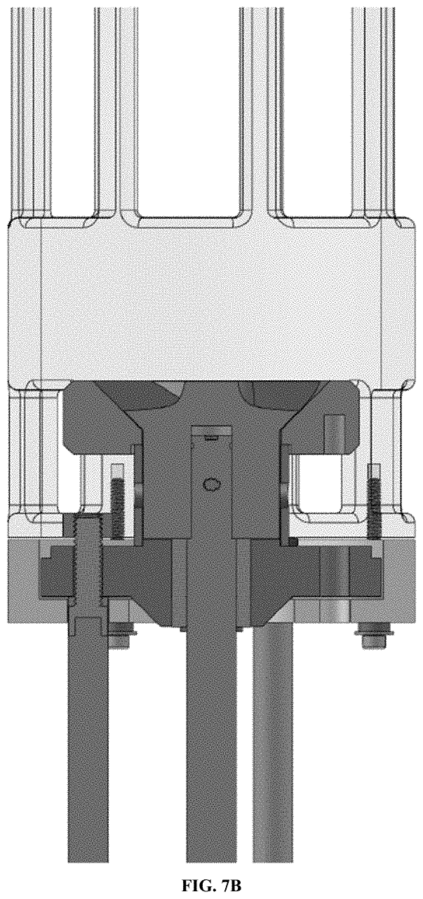

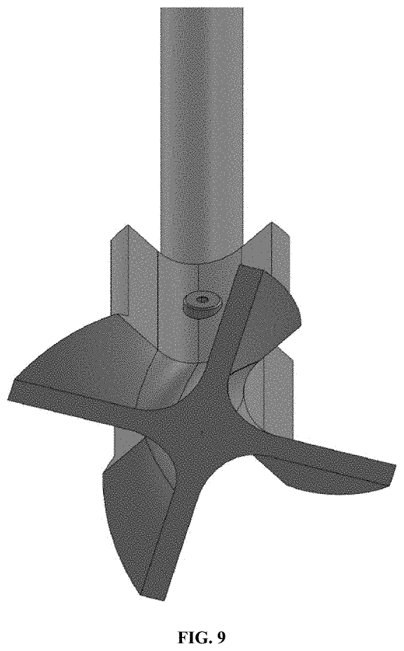

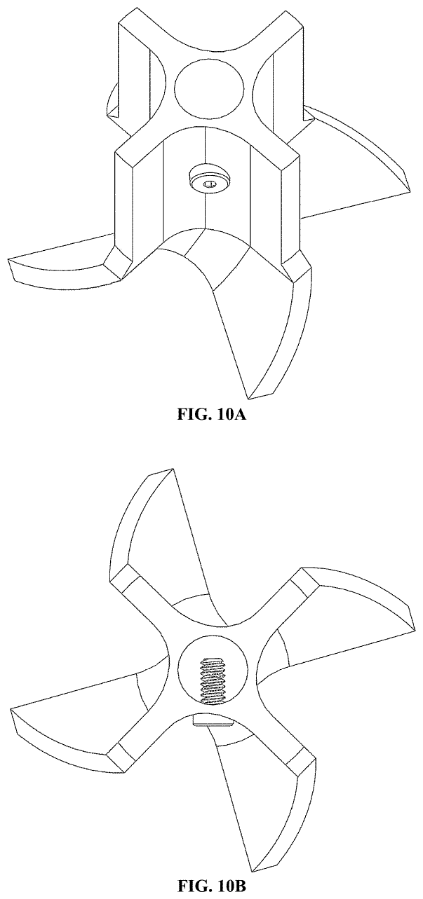

FIGS. 7A-7B illustrate a portion of a beverage brewing device 700 according to an alternative aspect of the disclosure. FIG. 7A is a partially-transparent front view of a portion of this beverage brewing device 700, showing a pumping rotor-stator assembly 701 situated within the device. FIG. 7B provides a cross-sectional view of the device shown in FIG. 7A. FIG. 8A is a perspective view of this same pumping rotor-stator assembly 701. In this configuration, the rotor-stator assembly 701 is shown affixed to the underside of a framework 702. This configuration differs from that of the exemplary rotor-stator assemblies 501 depicted in FIGS. 5A-5D, which are shown attached to the upper surface of a framework 502. In this view, all components are rendered as solids. FIG. 8B is a version of the perspective view shown in FIG. 8A, where the baffle 703 of this exemplary rotor-stator assembly 701 is partially transparent. Similarly, FIG. 8C is a version of the perspective view shown in FIG. 8A, where both the baffle 703 and stator 704 components of the rotor-stator assembly 701 are partially transparent. FIG. 8D is a perspective view of the rotor-stator assembly 701 affixed to a portion of a beverage brewing device 700 shown in FIG. 8A, without the baffle 703 and stator 704 components, providing a direct view of the rotor 705 used in this exemplary aspect. FIG. 9 provides a perspective view of this same rotor, shown attached to an axle 706. FIGS. 10A and 10B provide a perspective and a top view of this rotor without the axle 706. As illustrated by these figures, the rotor used in this exemplary aspect comprises a four-flute design with curved fins extending from each of the four flutes. As discussed above, fins may be incorporated into a rotor to modify the flow of liquid entering and exiting the stator and/or to the flow of liquid within the grinding container of a beverage brewing device.

Additional beverage brewing devices may be designed in accordance with the disclosure. In some aspects, a beverage brewing device may comprise a first container, having a top end and a bottom end; a second container adapted to attach to the bottom end of the first container, comprising a rotor-stator assembly and a filter, wherein the rotor-stator assembly is positioned within the second container; and a base adapted to attach to the bottom end of the first container, comprising a motor configured to operate the rotor-stator assembly. In some aspects, the device may optionally include a spout, lid, and/or handle.

In some aspects, the filter may be removable. The filter may be attachable to the second container by a hinge, clasp, or any other means for securing the filter to the second container. The filter may be constructed from metal, plastic, fabric, or any other suitable material and the pore size of the filter may vary depending on the size of the ground material used to prepare a beverage with the device. For example, the second container may include a rotor-stator assembly configured to finely grind coffee beans (or other materials), which may require that the filter have a small pore size to isolate the ground coffee. Alternatively, the second container may include a rotor-stator assembly configured to coarsely grind coffee beans (or other materials), which may require that the filter have a larger pore size.

In some aspects, devices according to this general design may be provided as a system comprising a first container and base and a plurality of second containers, each second container having a rotor-stator assembly configured to provide a different level of grinding. In some aspects, the second container is structured as a pod or canister.

The base may include a motor configured to drive the rotor-stator assembly and an optional power supply to power said motor. In some aspects, the power supply comprises a battery. Alternatively, the motor and/or the power supply may be connectable to an external power outlet. In some aspects, the motor is powered by a battery included in the base.

In some aspects, the rotor-stator assembly is activated by a switch positioned on the first container, on the base, or elsewhere on the coffee brewing device. The switch may be manually controlled by a human operator (e.g., a push-button or toggle), subject to a mechanical or digital timer, or computer-controlled.

In some aspects, a beverage brewing device is configured to communicate wirelessly with a cellular phone, computer or other electronic device allowing a user to activate the rotor-stator assembly or otherwise operate the device remotely. In some aspects, the device is configured to communicate with software running on a cellular phone or other mobile device which is able to schedule operation of the device (e.g., activating the rotor-stator assembly at specific times set by a user).

In some aspects, the first container or the base may include a heating element configured to heat the liquid contained in the first container and/or to maintain a user-selected temperature. This heating element may be configured by a user manually (e.g., using a switch or panel on the device) or remote-controlled via a cellular phone, computer or other electronic device. In some implementations, the heating element may be configured to activate and/or adjust the temperature according to a user-defined schedule or profile.

In some aspects, a beverage brewing device may be configured to store and/or use one or more profiles. Profiles may be user-specific or specific to a given type of beverage or a brewing protocol. Profiles may be created on the device and stored in non-volatile memory and/or transferred to the device from a user's cellular phone, computer or other electronic device. For example, the device may include a profile for a first user that sets forth a brewing protocol which uses a particular grinding speed for the rotor-stator assembly and/or which sets the heating element to a particular temperature. The device may include a profile for a second user having alternative parameters.

Beverage brewing devices disclosed herein may be used to brew coffee or other beverages based on beans or any other edible material which may be ground and steeped in a liquid to produce a beverage suitable for human consumption. For simplicity, the beverage brewing methods described herein refer to the use of coffee beans. However, it is understood that in other aspects according to the disclosure alternative materials (e.g., tea leaves and other plant-derived materials) may be ground by the devices disclosed herein and steeped in liquid to produce beverages suitable for human consumption. In some aspects, a beverage may comprise two or more different materials, such as a mixture of coffee beans and an additional edible material to be infused into the coffee during the brewing process (e.g., a fruit, a spice, cocoa, or any other edible material selected to provide flavor, nutritional value, or any other desired trait).

Beverage brewing devices according to some aspects of the disclosure may be operated by adding coffee beans to the second container, closing the second container (e.g., by attaching the filter), and attaching the second container (now containing coffee beans) to the bottom end of the first container. As indicated above, the motor configured to drive the rotor-stator assembly may be included as part of the first container or located within a separate base. Once assembled, coffee may be brewed by adding sufficient liquid to the first container to fully or partially submerge the coffee beans located in the second container, and activating the rotor-stator assembly (e.g., using a switch) positioned on the first container or the base. At this stage, various components of the coffee beans will then be extracted by the liquid (e.g., by dissolving into the liquid or forming an emulsion), passing through the filter and gradually converting the liquid placed in the first container into a coffee beverage.

A second container compatible with a coffee brewing device may comprise one or more filters across any surface of the second container. In some implementations, the lateral wall(s) of the second container include one or more filter regions. In some implementations, the entire upper and lateral surface of the second container may comprise a filter. Alternatively, discrete filter regions may be placed at multiple points along the lateral and/or upper surface of the second container. Filter regions may also be placed on the surface which is configured to attach to the first container.

One or more of the filter regions on the second container may be detachable (e.g., allowing a user to open the second container in order to insert coffee beans or other edible material(s) to be ground within the second container). In some implementations, the detachable filter is attached by a hinge, faster, locking mechanism or any other means of securing the filter to the second container. The second container may alternatively be configured to allow a user to open the second container along a surface that does not contain a filter. For example, a second container (with a filter along the upper surface) may be structured as two halves (e.g., a first half comprising the filter and a portion of the side wall(s) and a second half comprising the bottom surface, rotor-stator assembly and a portion of the side wall(s)). These halves may be threaded along the interface between the two halves allowing a user to join or separate the halves by rotating the two halves in opposite directions along this interface. In other implementations, the second container may include a surface (e.g., a filter region, or a solid region) which can be manipulated by a user to open the second container, such as a solid surface that detaches from the second container or rotates along a hinge to allow access to the inside of the second container.

The second container may generally be structured as any enclosed volume adapted to fit within a larger brewing container (e.g., the first container), having a means for grinding coffee beans or other edible material(s) contained within the volume and at least one interface allowing contact between a liquid placed in the brewing container and the contents of the enclosed volume. In some aspects, the second container is a pod, chamber, compartment, capsule, case or other vessel.

In some aspects, the first container may be substantially larger than the second container, e.g., to hold large volumes of liquid. For example, the first container may be sized to hold 1-10 L, 10-100 L, 100-1000 L or >1000 L. The contents of the first container may be water used to make commercial volumes of a beverage that will later be dried or freeze-dried (e.g., to make instant coffee), served to consumers, or bottled for future sale. In some aspects, the liquid in the first container may be water or another beverage (e.g., beer or liquor) and the second container may contain one or more edible additives, nutritional or dietary supplements, flavoring agents or enhancers, or other compounds to be ground and infused into the beverage contained in the first container.

Brewing Methods

Various beverages, and in particular coffee beverages, may be brewed using the devices and methods described herein. In some aspects, a beverage may be brewed by providing one or more edible organic material(s), and optionally one or more edible inorganic materials (e.g., salts); placing at least a portion of the edible material(s) in any of the rotor-stator assemblies described herein; submerging the rotor-stator assembly in a liquid, wherein the liquid is sufficient to fully or partially submerge the edible material(s); grinding the edible material(s) using the rotor-stator assembly; and generating a beverage. In some aspects, the beverage may be generated by further steeping the ground-up edible material(s) in the liquid. In some aspects, the foregoing method is performed using a pod described herein which comprises the rotor-stator assembly. Any material suitable for human consumption may be used to brew a beverage according to this general procedure. The steeping time and temperature, grinding speed and rotor-stator assembly configuration may be varied by a user based upon the edible material being used to brew the beverage (some material may require additional or reduced steeping time, a particular grinding speed, etc.). It is envisioned that parameters will be selected by a user depending on the application. As described above, devices according to the disclosure may allow a user to create, save and/or execute customization options and routines (e.g., user or beverage profiles). In some aspects, devices according to the disclosure may execute particular brewing protocols for different beverages using such profiles.

An exemplary protocol for brewing a coffee beverage according to the disclosure may include placing an amount of coffee beans in any of the pods described herein; placing the pod within a container; adding hot or cold water to the container; submerging or partially submerging the grinding pod in the hot or cold water in the container; generating coffee grinds by grinding the coffee beans using the rotor-stator assembly in the pod, wherein the grinding is subject to one or more selected parameters; optionally further steeping the coffee grinds in the hot or cold water; and obtaining the coffee beverage from the container. Variable parameters include the grinding speed, steeping temperature, and steeping time. In some aspects, grinding may initially proceed at high speed for a short time followed by a “mixing” process at a slower speed for a longer duration to enhance flavor and obtain a fuller extraction (e.g., 7000 rpm for 60 seconds followed by 700 rpm for 180 seconds).

When brewing a beverage using the devices and methods described herein, a user may vary any of the parameters described herein (e.g., the brewing temperature, steeping time, grinding speed, and/or rotor configuration), as desired for a given implementation. For example, a beverage may be brewed using hot or cold liquid, or liquid at an ambient temperature. Suitable temperatures for the liquid may comprise, e.g., 0-5° C., 5-10° C., 10-20° C., 20-30° C., 30-50° C., 50-80° C., 80-100° C., 100-120° C., or any integer value or subrange within these ranges. In some aspects, the temperature parameter refers to the temperature of the liquid at the time that it is added to the device. Alternatively, the temperature parameter may refer to a temperature maintained during the brewing process (e.g., by a heating element). The edible materials used to generate a beverage may be steeped for any amount of time suitable to produce a desired beverage, e.g., 1-5 mins., 5-10 mins., 10-15 mins., 15-20 mins., 20-25 mins., 25-30 mins., >30 mins., or any integer value or subrange within these ranges. In some aspects, the brewing time may be reflected as a maximum amount of time, e.g., less than 5, 10, 15, 20, 30 or 60 mins. The rotor-stator assembly may be operated at any grinding speed suitable to produce a desired degree of grinding, e.g., 1,000 RPM; 2,000 RPM, 3,000 RPM; 4,000 RPM; 5,000 RPM; 6,000 RPM; 7,000 RPM, 8,000 RPM; 9,000 RPM; 10,000 RPM; 11,000 RPM; 12,000 RPM, 13,000 RPM; 14,000 RPM; 15,000 RPM; 16,000 RPM; 17,000 RPM, 18,000 RPM; 19,000 RPM; 20,000 RPM; 21,000 RPM; 22,000 RPM; 23,000 RPM; 24,000 RPM; 25,000 RPM; 26,000 RPM; 27,000 RPM; 28,000 RPM; 29,000 RPM; 30,000 RPM; or >30,000 RPM; or a speed within a subrange with endpoints comprising any of the aforementioned values.

In some brewing methods according to the disclosure, the edible materials may be ground for up to (or at least) 1-5 minutes, 5-10 minutes, 10-15 minutes, 15-20 minutes. In some aspects, the edible materials are ground for up to (or at least) 1, 2, 3, 4, 5, 6, 7, 8, 9, 10, 11, 12, 13, 14, 15, 20, 25, or 30 minutes. In some aspects, the beverage is ready for consumption immediately after the grinding process ends. In others aspects, grinds in the container may be allowed to steep in the liquid for an additional 1, 2, 3, 4, 5, 6, 7, 8, 9, 10, 11, 12, 13, 14, 15, 20, 25, or 30 minutes. In some aspects, steeping may proceed over a longer period of time, e.g., for at least (or up to) 1, 2 3, 4, 5, 6, 7, 8, 12, 16, 24, 48, or 72 hours. It is understood that steeping may be useful when preparing a coffee beverage and may be necessary or preferred when preparing a beverage based on other edible materials. In some cases, the grinding and/or steeping may take place over a span of between 0.5 to 10 minutes at 0-10° C. (e.g., to produce a cold brew coffee beverage) or 0.5 to 10 minutes at 80-100° C. (e.g., to produce a hot coffee beverage). Brewing may proceed using any temperature and time parameters selected by a user to produce a given beverage. Exemplary parameters include a brewing temperature between 0-100° C. and a brewing time of 0.5-60 minutes. However, these ranges are expressly non-limiting. In some cases, higher temperatures and longer brewing times may be preferred. After a sufficient amount of time has passed to complete the steeping process, a user may pour the beverage from the beverage brewing device.

Coffee brewed using the devices and methods described herein may advantageously be prepared in a short period of time (e.g., <5 minutes) while possessing many of the properties associated with cold brew coffee which normally requires ˜14 hours of steeping. In some aspects, coffee may be brewed by steeping for less than 5, 10 or 20 minutes at any temperature between 0 and 100° C.

Coffee Beverage Compositions

Coffee compositions described herein may contain one or more compounds which are normally not extracted by conventional brewing methods and/or unique concentrations of compounds found in conventionally brewed coffee beverages. For example, coffee compositions according to the present disclosure may contain enriched levels of total fats, polyunsaturated fats, antioxidants and other compounds of interest. In some implementations, such coffee beverages may include one or more of the following: at least 0.25% total fat, at least 0.1% saturated fat, at least 0.1% polyunsaturated fat, and/or at least 0.1% trans-fat. In some aspects, the coffee composition may have at least 0.10%, 0.15%, 0.20%, 0.30%, 0.35%, 0.40%, 0.45% or 0.50% total fat, or a total fat concentration within the range of 0.10%-0.50%, 0.20%-0.40%, 0.25%-0.35%, or any combination of minimum and maximum values therein. In some aspects, the coffee composition may have at least 0.05%, 0.15%, 0.20%, 0.25%, 0.30%, 0.35%, 0.40%, 0.45% or 0.50% saturated fat, or a saturated fat concentration within the range of 0.05%-0.50%, 0.1%-0.40%, 0.15%-0.35%, or any combination of minimum and maximum values therein. In some aspects, the coffee composition may have at least 0.05%, 0.15%, 0.20%, 0.25%, 0.30%, 0.35%, 0.40%, 0.45% or 0.50% polyunsaturated fat, or a polyunsaturated fat concentration within the range of 0.05%-0.50%, 0.1%-0.40%, 0.15%-0.35%, or any combination of minimum and maximum values therein.

Coffee compositions disclosed herein may have a polyphenol concentration of ≥100 mg/100 ml, ≥125 mg/100 ml, ≥150 mg/100 ml, 50-250 mg/100 ml, 100-200 mg/100 ml, 125-175 mg/100 ml, or any integer value within these ranges.

Coffee compositions may also have a particulate concentration of ≤5 mg/mL, ≤6 mg/mL, ≤7 mg/mL, ≤10 mg/mL, or a particulate concentration within the range of 5-7 mg/mL, 4-8 mg/mL, 3-9 mg/mL, 2-10 mg/mL, 1-11 mg/mL or any or any combination of minimum and maximum integer values within these ranges.

As discussed above, coffee brewing methods and devices provided herein may be capable of generating coffee having a unique extraction profile compared to coffee produced via conventional brewing methods. For example, coffee produced by the present methods may have a higher concentration of total fat, fatty acids and antioxidants compared to conventional drip-based and French press brewing methods and without the long steeping time requirements of cold brew methods.

It is understood that the concentration or amount of extracted compounds will vary depending on the degree of roasting of the coffee beans used to produce a coffee beverage. Higher temperatures and/or prolonged roasting changes the chemical composition of coffee beans. For example, the level of caffeine in “blond roast” coffee beans will typically be higher than the level of caffeine in coffee beans obtained from the same source which have been subjected to “medium roast” or “dark roast” processing because a larger portion of the caffeine will undergo chemical decomposition during the extended roasting process. However, expected concentrations and amounts of extracted compounds obtained from coffee beans subjected to “blond roast,” “dark roast” or other such levels of roasting may be extrapolated simply accounting for the higher or lower starting amounts and presuming the same linear relationship across different w/v ratios. Consequently, it is understood that all of the amounts, concentrations and ranges of these values disclosed herein may be adjusted to account for alternative w/v ratios and the roasting level of coffee beans used to produce a given coffee beverage. Adjustment of these value may include accounting for an alternative starting amount of a given compound in the coffee beans or grounds used to brew the beverage and projecting that the resulting beverages will display the same linear relationship with regard to the concentration of amount of the compound across various w/v ratios.

In some aspects, beverage brewing devices according to the disclosure may be capable of producing a coffee having approximately 160 mg/100 mL of polyphenols (e.g., using medium roast coffee beans). In contrast, a standard drip coffee brewing method may produce a coffee from medium roast coffee beans having approximately 130 mg/100 mL of polyphenols, under comparable conditions. Similarly, in some aspects, the present methods may be capable of extracting more polyphenol compounds (e.g., antioxidants) from ground coffee, surpassing the 130 mg/mL expected to result from a conventional drip-based method (assuming a 6% coffee solids to water ratio and medium roast coffee beans). In some aspects, the present methods may be capable of extracting approximately 1.5× more total fat from ground coffee than French press coffee methods (i.e., 0.30% total fat, which assumes 6% coffee solids to water ratio). The amount of total fat extracted may be unaffected by the brewing temperature. In contrast, standard coffee brewing methods typically provide poor extraction of total fat and a standard drip-based protocol produced zero extraction. Similar improvements may be observed when light or dark roast coffee beans are used.

In some aspects, coffee produced using the current methods may comprise more caffeine than conventional methods when brewed with a hot steeping step (77 mg/100 ml). In some aspects, a cold brewing protocol using the present methods may be capable of producing a beverage comparable to cold brew, with respect to caffeine content, in substantially less time (e.g., 5 minutes versus ˜14 hours). In some aspects, standard and cold brewing protocols using exemplary methods of the present disclosure may produce coffee with an omega-6 and omega-3 fatty acid concentration that noticeably exceeds standard cold brew and French press techniques. As noted above, standard drip-based methods typically fail to extract any measurable level of fatty acids.

Other Beverage Compositions

Devices and methods according to the present disclosure may be used to brew coffee as described in detail above. However, it is understood that the present devices and methods may also be used to brew any other beverage suitable for human consumption and may also be used to mix a beverage with additional components (e.g., additional flavoring agents or flavor enhancers, dietary supplements, and other beneficial compounds). For example, a coffee beverage may be brewed according to any of the methods described herein, with an additional flavoring agent or nutritional supplement added to the pod prior to grinding such as fruit, chocolate, one or more spices or extracts, and any other compound(s) or edible material(s) that can be ground by the rotor-stator assembly provided in the pod in order to produce a coffee beverage infused with the additional edible materials. Alternatively, the present methods may be used to brew or enhance non-coffee beverages such as tea, juice, hot-chocolate, liquor or beer. Such beverages may be generated by infusing ground up edible materials into water or by infusing these materials into a pre-existing beverage to enhance its flavor, nutritional value, or to provide other beneficial properties. In some aspects, the resulting or enhanced beverage may be subsequently freeze dried or otherwise preserved to allow later consumption or for commercial distribution.

### Examples

An exemplary beverage brewing device using a rotor-stator assembly according to the disclosure, and a comparative device using a blade grinder, were used to brew coffee under hot and cold temperature conditions. This study also evaluated the use of a 2-flute and a 4-flute rotor configuration, in this case using a 2-flute configuration with flutes oriented in different horizontal planes (e.g., as shown in FIG. 1A) and a 4-flute configuration with all flutes oriented in the same horizontal plane. The results of this study confirm that devices using rotor-stator assembly according to the disclosure produce a superior beverage having a lower concentration of particulates compared to the beverage produced using a blade grinder.

In brief, 75 g of medium roast coffee beans were added to a pod comprising either a rotor-stator assembly having a 2-flute rotor, a rotor-stator assembly having 4-flute rotor, or a blade grinder. All of the pods used in this study were otherwise structurally identical and comprised a container with a sidewall having a 100-mesh filter. The loaded pods were subsequently inserted into a beverage brewing device according to the disclosure and a total of 1.5 L of hot (˜95° C.) or cold (˜3° C.) water was added to each device, fully submerging the rotor-stator assembly or blade grinder in each case. Grinding proceeded at either high-speed for the hot cohort or low-speed for the cold cohort, for either ˜50 or ˜90 seconds as described on the charts below. After grinding was complete, the beverages were allowed to steep for an identical amount of time. The resulting beverages were collected and measured to determine the concentration of particulates in these beverages. The grind cake remaining in the device was also measured.

HOT BREWING TEST (−95° C.)

| | | | Grind Cake | Parti- |
|---|---|---|---|---|
| Grinding | Process | | Volume | culates |
| Mechanism | Time (s) | Physical Intervention | (mL) | in Liquid |
| Blade Grinder | ~90 | None | ~100 | +++ |
| Rotor/Stater | ~90 | Disruptive force needed | ~300 | + |
| (4-Flute) | | to start grinding | | |
| Rotor/Stater | | | | |
| (2-Flute) | ~50 | None | ~300 | + |

COLD BREWING TEST (~3° C.)

| | | | Grind Cake | Parti- |
|---|---|---|---|---|
| Grinding | Process | | Volume | culates |
| Mechanism | Time (s) | Physical Intervention | (mL) | in Liquid |
| Blade Grinder | ~90 | None | ~60 | +++++ |
| Rotor-Stater | ~90 | Disruptive force needed | ~200 | +++ |
| (4-Flute) | | to start grinding | | |
| Rotor-Stater | ~50 | None | ~250 | ++ |
| (2-Flute) | | | | |

As illustrated by the charts shown below, the 2- and 4-flute rotor-stator assemblies according to the disclosure produces superior results under both hot and cold brewing conditions, compared to a blade grinder (e.g., displaying a lower particulate size). The relative volume of the grind cake confirms the particulate size data. A low volume of remaining grind cake indicates that the particulate size was optimized (e.g., a size within the range of 150 to 1,000 μl). The 2-flute configuration of the rotor (with each flute oriented in a different horizontal plane) was also found to be preferable to the 4-flute configuration (with all flutes oriented in the same horizontal plane), in that this rotor was able to proceed with grinding immediately. In contrast, the 4-flute rotor configuration required an initial disruptive force (e.g., a jolt) in order for the rotor to begin grinding coffee beans. Without being bound to a theory, it is believed that the larger volume in the stator of the 2-flute rotor configuration is better able to accommodate the size of an intact coffee bean. The ideal rotor configurations for a given edible material may thus be at least partially dependent on the starting size of the edible material to be ground by the device.

1. A rotor-stator, comprising:
a rotor rotatable about a central axis comprising at least one flute extending outward from the central axis; and
a stator comprising a cylindrical casing surrounding the rotor and comprising one or more holes;
wherein the rotor-stator is capable of grinding solid edible materials in a liquid.

2. The rotor-stator of claim 1, wherein the rotor comprises two flutes extending outward from the central axis, wherein each flute is positioned at a different plane along the central axis and there is only one flute per plane.

3. The rotor-stator of claim 1, wherein the rotor comprises three flutes extending outward from the central axis, wherein each flute is positioned at a different plane along the central axis and there is only one flute per plane.

4. The rotor-stator of claim 1, wherein the rotor comprises four flutes extending outward from the central axis, wherein each flute is positioned at a different plane along the central axis and there is only one flute per plane.

5. The rotor-stator of any one of claims 1-4, further comprising a baffle positioned above the stator.

6. The rotor-stator of claim 5, wherein the baffle is integrally attached to the stator.

7. The rotor-stator of claim 1, comprising a single flute extending outward from the central axis.

8. The rotor-stator of claim 1, comprising a single flute extending outward from the central axis, wherein the single flute is counter-balanced by a portion of the rotor that is not a flute.

9. The rotor-stator of any one of claims 1-6, wherein the rotor comprises a plurality of flutes extending outward from the central axis, wherein each flute is positioned in a different plane along the central axis.

10. The rotor-stator of any one of claims 1-4, wherein the rotor is adapted to grind edible materials having a unit size within 10% of the size of a horizontal cross-section of the stator addressable for grinding.

11. The rotor-stator of any one the preceding claims, wherein the solid edible materials comprise coffee beans.

12. The rotor-stator of any one the preceding claims, wherein the cylindrical casing surrounding the rotor comprises a plurality of holes.

13. The rotor-stator of any one the preceding claims, wherein the cylindrical housing surrounding the rotor comprises a plurality of holes having a diameter of approximately: 0.25 mm, 0.50 mm, 0.75 mm, 1.00 mm, 1.25 mm, 1.50 mm, 1.75 mm, 2.00 mm, 2.25 mm, 2.50 mm, 2.75 mm, 3.00 mm, 3.25 mm, 3.50 mm, 3.75 mm, 4.00 mm, 4.25 mm, 4.50 mm, 4.75 mm, 5.00 mm, 5.25 mm, 5.50 mm, 5.75 mm, 6.00, 6.25 mm, 6.50 mm, 6.75 mm, 7.00 mm, 7.25 mm, 7.50 mm, 7.75 mm or 8.00 mm.

14. The rotor-stator of any one the preceding claims, wherein the cylindrical housing surrounding the rotor comprises a plurality of holes having a diameter in the range of 0.01-0.50 mm, 0.50-1.00 mm, 1.00-1.50 mm, 1.50-2.00 mm, 2.00-2.50 mm, 2.50-3.00 mm, 3.00-3.50 mm, 3.50-4.00 mm, 4.00-4.50 mm

15. The rotor-stator of any one the preceding claims, wherein the rotor-stator is configured to generate a particle size of 150-1,000 μm.

16. The rotor-stator of any one the preceding claims, wherein the rotor-stator is configured to generate a particle size within a range of: 50-200 μm; 100-200 μm; 200-300 μm; 300-400 μm; 400-500 μm; 500-600 μm; 600-700 μm; 700-800 μm; 800-900 μm; 900-1,000 μm; or within a range wherein the endpoints comprise any pair of the preceding values.

17. A pod adapted for use with a beverage brewing device, comprising:
an upper wall;
a lower wall;
one or more side walls connecting the upper wall and the lower wall to form a compartment; and
a rotor-stator attached to an inner surface of the compartment;
wherein at least a portion of the upper wall, the lower wall, and/or the one or more side walls comprises a filter or opening adapted to allow fluid communication through the pod;
wherein the rotor-stator comprises the rotor-stator of any of the preceding claims.

18. The rotor-stator of any one of claims 1-16, or the pod of claim 17, wherein the rotor-stator assembly is adapted to grind coffee beans.

19. The pod of any one of claim 17 or 18, wherein the pod is configured to allow detachment of the filter from the pod.

20. The pod of any one of claims 17-19, wherein the filter is attached to the pod by at least one hinge or clasp.

21. The pod of any one of claims 17-19, wherein an outer surface of the pod is configured to attach to a surface of a container and the container comprises one or more of the following:
a fluid reservoir;
a motor configured to drive the rotor-stator assembly;
a switch configured to activate the rotor-stator assembly; and/or
a power supply configured to power the rotor-stator assembly.

22. The pod of any one of claims 17-20, wherein an outer surface of the pod is configured to attach to a surface of a container, the container comprises a fluid reservoir and is attached to a base, and the base comprises one or more of the following:
a motor configured to drive the rotor-stator assembly;
a switch configured to activate the rotor-stator assembly; and/or
a power supply configured to power the rotor-stator assembly.

23. The pod of any one of claims 17-22, wherein the filter comprises:
a mesh filter;
a solid support having one or more pores; and/or
a porous material configured to allow fluid communication across the material while retaining edible material grinds.

24. The pod of any one of claims 17-22, wherein the pod further comprises:
a cap adapted to attach to the pod, the cap defining an upper wall of the pod.

25. A beverage brewing device, comprising:
the pod of any one of claims 17-22;
a container, having a top end and a bottom end;
wherein the pod is configured to attach to an inner surface of the bottom end of the container, and optionally, the top end; and
a base adapted to attach to the bottom end of the container, comprising a motor configured to operate the rotor-stator assembly.

26. A beverage brewing device, comprising:
the pod of any one of claims 17-22;
a first base, adapted to allow the pod to attach to an upper surface of the first base;
a second base, adapted to allow the first base to attach to an upper surface of the second base, wherein the second base comprises a power supply configured to power the rotor-stator assembly and a motor configured to operate the rotor-stator assembly; and
a container, having a top end and a bottom end, wherein at least a portion of the bottom end comprises a filter adapted to allow fluid communication between the container and the pod;
wherein the pod is configured to attach to an inner surface of the bottom end of the container.

27. A beverage brewing device, comprising:
the pod of any one of claims 17-22;
a container, having a top end and a bottom end;
wherein the container is configured to allow attachment of the pod to an inner surface of the top end and an inner surface of the bottom end of the container; and
a base adapted to attach to the bottom end of the container, comprising a motor configured to operate the rotor-stator assembly.

28. A beverage brewing device, comprising:
the pod of any one of claims 17-20;
a container, having a top end and a bottom end;
wherein the container is configured to allow attachment of the pod to an inner surface of the bottom end of the container;
a base adapted to attach to the bottom end of the container, comprising a motor configured to operate the rotor-stator assembly; and
a support framework extending along a vertical axis of the container, adapted to attach to the pod.

29. A beverage brewing device, comprising:
the rotor-stator assembly of any one of claims 1-16;
a container, having a top end and a bottom end;
wherein the rotor-stator assembly is configured to attach to an inner surface of the bottom end of the container, and optionally, the top end; and
a base adapted to attach to the bottom end of the container, comprising a motor configured to operate the rotor-stator assembly.

30. A beverage brewing device, comprising:
the rotor-stator assembly of any one of claims 1-16;
a container, having a top end and a bottom end;
wherein the container is configured to allow attachment of the rotor-stator assembly to an inner surface of the top end and an inner surface of the bottom end of the container; and
a base adapted to attach to the bottom end of the container, comprising a motor configured to operate the rotor-stator assembly.

31. A beverage brewing device, comprising:
the rotor-stator assembly of any one of claims 1-16;
a container, having a top end and a bottom end;
wherein the container is configured to allow attachment of the rotor-stator assembly to an inner surface of the bottom end of the container;
a base adapted to attach to the bottom end of the container, comprising a motor configured to operate the rotor-stator assembly; and
a support framework extending along a vertical axis of the container, adapted to attach to the rotor-stator assembly.

32. The beverage brewing device any one of claims 25-31, wherein the base and/or the container comprises at least one of the following:
a heating element adapted to heat or maintain the temperature of a liquid stored in the container;
a switch configured to activate the rotor-stator assembly; and/or
a power supply configured to power the rotor-stator assembly.

33. A method of brewing a beverage, comprising:
placing an edible material in the rotor-stator assembly of any one of claims 1-16 or the pod of any one of claims 17-22;
submerging the rotor-stator assembly in a liquid, wherein the liquid is sufficient to fully or partially submerge the edible material;
grinding the edible material using the rotor-stator assembly; and
generating a beverage by steeping the ground-up edible material in the liquid.

34. The method of claim 33, wherein the edible material is subjected to grinding for:
a) at least 0.25, 0.5, 0.75, 1, 2, 3, 4, 5, 6, 7, 8, 9, 10, 15 or 20 minutes; and/or
b) less than 0.25, 0.5, 0.75, 1, 2, 3, 4, 5, 6, 7, 8, 9, 10, 15, or 20 minutes.

35. The method of claim 33 or 34, wherein the edible material is subject to grinding at a temperature of:
a) 0-25° C.;
b) 15-25° C.; or
c) 1-15° C.

36. The method of any one of claims 33-35, wherein the edible material comprises a plurality of coffee beans.

37. A method of brewing a coffee beverage, comprising:
placing an amount of coffee beans in the pod of any one of claims 17-22;
placing the pod within a container;
adding hot or cold water to the container;
at least partially submerging the pod in the hot or cold water in the container; and
generating coffee grinds by grinding the coffee beans using the rotor-stator assembly in the pod; and
optionally, further steeping the coffee grinds in the hot or cold water.

38. The method of claim 37, wherein the amount of coffee beans placed in the pod is any one of the following: 20 g, 5-20 g, 10-30 g, 15-40 g, 20-50 g or >50 g.

39. The method of claim 37 or 38, further comprising:
attaching the pod to a support framework prior to placing the pod in the container, wherein the support framework is attached to an upper surface or a lower surface of the pod.

40. The method of claim 37, wherein a volume of the hot or cold water added to the container is: 100-200 mL, 201-300 mL, 301-400 mL, 401-500 mL or >500 mL.

41. The method of claim 37, wherein grinding the coffee beans in the hot or cold water comprises grinding for any one of the following durations of time: <2 minutes, <5 minutes, 1-3 minutes, 2-4 minutes, 3-6 minutes, 4-7 minutes, 5-8 minutes, 6-9 minutes, 7-10 minutes, or >10 minutes.

42. The method of claim 37, wherein adding the hot or cold water to the container comprises adding the hot or cold water having a temperature of: 0-5° C., 5-10° C., 10-20° C., 20-30° C., 30-50° C., 50-80° C. or 80-100° C.

43. A coffee composition prepared by wet-grinding coffee beans using a rotor-stator assembly.

44. A coffee composition prepared by wet-grinding coffee beans using the rotor-stator assembly of any one of claims 1-16.

45. A method of brewing coffee, comprising:
providing a coffee brewing device comprising
a first container, having a top end and a bottom end;
a second container adapted to attach to the bottom end of the first container, comprising a rotor-stator assembly and a filter;
wherein the grinder is positioned within the second container; and
a base adapted to attach to the bottom end of the first container, comprising a motor configured to operate the rotor-stator assembly;
placing a plurality of coffee beans within the second container;
adding liquid to the first container sufficient to fully or partially submerge the coffee beans in the second container; and
generating coffee by grinding the submerged coffee beans and allowing soluble and/or extractable components of the coffee beans to dissolve or form an emulsion in the liquid.

46. A method of brewing coffee, comprising:
providing a plurality of coffee beans;
submerging at least a portion of the plurality of coffee beans in a liquid;
grinding the plurality of coffee beans using a rotor-stator assembly while the portion of the plurality of coffee beans are submerged in the liquid to produce coffee grinds; and
generating the coffee by steeping the coffee grinds in the liquid.

47. The method of claim 45 or 46, wherein the liquid added to the container is at least:
0-100° C., 0-20° C., or 80-100° C., when added to the container.

48. The method of any one of claims 45-47, wherein extractable components of the coffee beans are allowed to dissolve and/or form an emulsion in the liquid over a period of at least:
0.5 to 10 minutes;
10 to 30 minutes; or
30 to 90 minutes.

49. A method of brewing coffee comprising:
at least partially submerging coffee beans in container comprising water, wherein there is an approximately 6% w/v ratio of coffee beans to water; and
grinding the coffee beans using a rotor-stator assembly to obtain coffee,
wherein the coffee comprises at least 0.25% total fat, at least 0.1% saturated fat, at least 0.1% polyunsaturated fat, at least 140 mg/100 ml polyphenol content, at least 65 mg/100 ml caffeine content, a substantially brown color, and/or a particulate concentration of ≤10 mg/mL.

50. The method of claim 49, wherein the ratio of coffee beans to water are at a ratio other than 6% but the relationship of the ratio to total fat, saturated fat, polyunsaturated fat, polyphenol content, caffeine content, and/or a particulate concentration remains linear.

51. The method of claim 49 or 50, wherein the water has a temperature of 0 to 25° C.

52. The method of claim 49 or 50, wherein the coffee is brewed within 5, 10, 15, 20, 25, 30, 35, 40, 45, 50, 55 or 60 minutes.

53. The method of claim 49 or 50, wherein the coffee is brewed within 5, 10, 15, 20, 25, 30, 35, 40, 45, 50, 55 or 60 minutes and the water has a temperature of 0 to 25° C.

54. The rotor-stator assembly of any one of claims 1-16 or the pod of any one of claims 17-22, wherein the rotor-stator assembly or the pod comprises two or more filters with different pore sizes.

55. The rotor-stator assembly or pod of claim 54, wherein at least one of the filters has a pore size selected from or within the range of:
a) 10 μm, 20 μm, 30 μm, 40 μm, 50 μm, 60 μm, 70 μm, 80 μm, 90 μm, or 100 μm;
b) 10 μm-1,000 μm;
c) 10-50 μm, 10-100 μm, 10-250 μm, 10-500 μm;
d) 20-60 μm, 30-70 μm, 40-80 μm, 50-90 μm, 60-100 μm; and/or
e) 100-200 μm, 200-300 μm, 300-400 μm, 400-500 μm, 500-600 μm, 600-700 μm, 700-800 μm, 800-900 μm, 900-1,000 μm.

56. A beverage brewing device comprising the rotor-stator assembly of any one of claims 1-16, or the pod of any one of claims 17-22.

57. A beverage produced by the beverage brewing device of claim 55, wherein the beverage comprises coffee having at least 0.25% total fat, at least 0.1% saturated fat, at least 0.1% polyunsaturated fat, at least 140 mg/100 ml polyphenol content, at least 65 mg/100 ml caffeine content, a substantially brown color, and/or a particulate concentration of ≤10 mg/mL.
